(19) United States
(12) Patent Application Publication
(10) Pub. No.: US 2015/0328588 A1
(43) Pub. Date: Nov. 19, 2015

(54) FILTRATION SYSTEMS AND MEMBRANES WITH ENHANCED FLUX AND METHOD FOR THEIR PREPARATION

(71) Applicant: BASF SE, Ludwigshafen (DE)

(72) Inventors: Joachim SCHMIDT-LEITHOFF, Mannheim (DE); Claudia STAUDT, Gau-Odernheim (DE); Michael KRAYER, Charlotte, NC (US); Dawid MARCZEWSKI, Limburgerhof (DE); Kevin NEIGH, Butler, PA (US); Thomas P. ANGERT, Renfrew, PA (US)

(73) Assignee: BASF SE, Ludwigshafen (DE)

(21) Appl. No.: 14/651,401

(22) PCT Filed: Dec. 16, 2013
(86) PCT No.: PCT/EP2013/076752

§ 371 Date: Jun. 11, 2015

Related U.S. Application Data
(60) Provisional application No. 61/737,956, filed on Dec. 17, 2012.
(60) Provisional application No. 61/737,942, filed on Dec. 17, 2012.
(60) Provisional application No. 61/737,870, filed on Dec. 17, 2012.

(30) Foreign Application Priority Data
Dec. 17, 2012 (EP) 12197526.2
Dec. 17, 2012 (EP) 12197556.9
Dec. 17, 2012 (EP) 12197599.9
Dec. 17, 2012 (EP) 12197613.8

(51) Int. Cl. B01D 67/00; B01D 65/08; C02F 1/44; B01D 71/56; B01D 71/68; B01D 61/18; B01D 69/12

(52) U.S. Cl. CPC B01D 67/0088; B01D 61/18; B01D 65/08; B01D 69/125; B01D 71/56; B01D 71/68; C02F 1/441; B01D 2325/48; B01D 2323/32; B01D 2321/168; C02F 2303/20

(57) ABSTRACT

Filtration system comprising at least one membrane, wherein at least one component or at least one part of a component of the filtration system has been obtained by a process comprising the following steps: A) treatment of a said component or part of a component with at least one organoborane-amine complex, B) treatment of a said component or part of a component with a composition comprising at least one radically polymerizable compound, C) optional treatment with a deblocking agent.

The present invention relates to filtration systems and membranes obtained by a process comprising the following steps:
A) treatment of a component or a part of a component with at least one organoborane-amine complex
A) treatment with a composition comprising at least one radically polymerizable compound
B) optional treatment with a deblocking agent.

The invention further relates to a process for making such membranes, the use of such membranes and to a method of increasing the flux through a membrane.

Different types of membranes play an increasingly important role in many fields of technology. In particular, methods for treating water rely more and more on membrane technology.

An important issue with the application of membranes is fouling. The problem of biofouling is pronounced in semipermeable membranes used for separation purposes like reverse osmosis, forward osmosis, nanofiltration, ultrafiltration and micro filtration. Membranes may be classified according to their separation mechanism and/or pore sizes. For example, in water filtration applications ultrafiltration and microfiltration membranes (approximate pore diameter: 5-1000 nm) are used for wastewater treatment retaining organic and bioorganic material. In reverse osmosis and forward osmosis membranes, where monovalent ions and all components with larger diameter are rejected, the separation mechanism is based mainly on solution-diffusion mechanism.

In all applications where the ambient medium is an aqueous phase, potential blockage may occur by adhesion of microorganisms and biofilm formation. As a consequence, a membrane is desired, which reduces biofilm formation and thus requires fewer cleaning cycles. This can for example be achieved through membranes with anti-adhesive or antifouling properties.

Thus, fouling is currently one of the major remaining problems for filtration membranes. Fouling causes deterioration of the membrane performance and shortens membrane lifetime, limiting further application of membrane technology. It is thus desirable to improve antifouling and antibacterial properties to membranes without impairing their separation characteristics in order to enhance their resistance.

Several approaches have been tried to solve the problem of fouling and biofouling and to prevent the formation and deposition of organic materials from organisms.

Recent research has focused on three strategies to prevent biofouling of membranes: 1) blending of hydrophilic or amphiphilic copolymers for the manufacture of membranes; 2) surface modification of membranes and 3) bulk modification of membrane materials.

The following documents describe approaches undertaken in recent years:
H. Yamamura, K. Kimmura, Y. Watanabe, Mechanism involved in the evolution of physically irreversible fouling in microfiltration and ultrafiltration membranes used for drinking water treatment, Environ. Sci. Technol. 41 (2007) 6789-6794.
V. Kochkodan, S. Tsarenko, N. Potapchenko, V. Kosinova, V. Goncharuk, Adhesion of microorganisms to polymer membranes: a photobactericidal effect of surface treatment with TiO2, Desalination 220 (2008) 380-385.
J. Mansouri, S. Harrisson, Vivki Chen, Strategies for controlling biofouling in membrane filtration systems: challenges and opportunities. J. Mater. Chem., 20 (2010)
U.S. Pat. No. 4,277,344 discloses antifouling approaches on RO layers, formed by interfacial reaction.
Desalination 275 (2011) 252-259, describes the grafting of PEG on a polyamide layer.
U.S. Pat. No. 6,280,853 and US 2010/043,733 disclose coatings of composite membranes with various polymers including polyalkylene oxide compounds or polyacrylamide compounds.
A. V. R. Reddy, D. J. Mohan, A. Bhattacharya, V. J. Shah, P. K. Ghosh, Surface modification of ultrafiltration membranes by preadsorption of a negatively charged polymer: I. Permeation of water soluble polymers and inorganic salt solutions and fouling resistance properties, J. Membr. Sci. 214 (2003) 211-221.
K. C. Khulbe, C. Feng, T. Matsuura, The art of surface modification of synthetic polymeric membranes, J. Appl. Polym. Sci. 115 (2010) 855-895.
B. Van der Bruggen, Chemical modification of polyethersulfone nanofiltration membranes: A review, J. Appl. Polym. Sci. 114 (2009) 630-642.
WO 2010/86852 discloses a method for modifying composite membranes for liquid separations by graft polymerization.
EP 186 758 discloses porous membranes having hydrophilic surface and processes for their manufacture.
WO 2005/44867 discloses borane based initiator systems for polymerizable compositions.
U.S. Pat. No. 4,894,165 discloses rejection enhancing coatings for RO membranes.

It was an object of the invention to provide filtration systems and membranes that are less prone to fouling.

This objective has been solved by a filtration system comprising at least one membrane, wherein at least one component or at least one part of a component of the filtration system has been obtained by a process comprising the following steps:
A) treatment of a said component or part of a component with at least one organoborane-amine complex
B) treatment of a said component or part of a component with a composition comprising at least one radically polymerizable compound
C) optional treatment with a deblocking agent.

In different embodiments of the invention, the component or part of the component in filtration systems according to the invention that is subjected to the above process steps is selected from a membrane, the separating layer of a membrane, a support layer of a membrane, a fabric layer of a membrane, the feed spacer of a membrane, the permeate spacer of a membrane, the casing of the filtration system, the piping of the filtration system, the joints of the filtration system, manifolds of the filtration system.

Normally the components suitable for the above process comprise an organic polymer as the main component.

In another aspect of the invention pertains to a process for making filtration systems, preferably comprising a membrane, comprising:
A) treatment of a said component or part of a component with at least one organoborane-amine complex
B) treatment of a said component or part of a component with a composition comprising at least one radically polymerizable compound
C) optional treatment with a deblocking agent.

It is an advantage of this process that it is not limited to certain parts or components of a filtration system. Rather, it can be applied to any component or part of a component of such filtration systems, if it comprises an organic polymer. Examples of suitable components or part s of components include a membrane, the separating layer of a membrane, a support layer of a membrane, a fabric layer of a membrane, the feed spacer of a membrane, the permeate spacer of a membrane, the casing of the filtration system, the piping of the filtration system, the joints of the filtration system, manifolds of the filtration system.

In another aspect of the invention pertains to membranes, obtained by a process comprising the following steps:
A) treatment of a base membrane with at least one organoborane-amine complex
B) treatment of a base membrane with a composition comprising at least one radically polymerizable compound
C) optional treatment with a deblocking agent.

The concept of a membrane is generally known in the art. In the context of this application a membrane shall be understood to be a thin, semipermeable structure capable of separating two fluids or separating molecular and/or ionic components or particles from a liquid. A membrane acts as a selective barrier, allowing some particles, substances or chemicals to pass through while retaining others.

Membranes according to the invention can for example be microporous (average pore diameter smaller than 2 nm), mesoporous (average pore diameter from 2 nm to 50 nm) or macroporous (average pore diameter above 50 nm). Average pore diameters in this context are determined according to DIN 14652:2007-09 through correlation with the molecular weight cutoff of a membrane.

In this application the term “membrane” shall, depending on the context, refer to a membrane according to the invention that comprises a coating obtained in a grafting process, or to a membrane that is subjected to a coating process to obtain a membrane according to the invention, or both.

Optionally, a membrane or the layer of a membrane that is used as starting material for a coating process to obtain a membrane according to the invention is sometimes referred to as a “base membrane”.

Thus, in case a membrane comprises more than one layer, the “base membrane” can refer to all layers of said membrane as a whole or to each of the layers of said membrane. The term “base membrane” usually refers to the layer that is subjected to the process steps A), B) and C) as defined above.

In one preferred embodiment, the base membrane refers to the separation layer of a membrane.

In another embodiment, the base membrane denotes the support membrane of a membrane, the protective layer or a nonwoven or woven support layer of a membrane.

Suitable membranes or the separation layer of suitable membranes can be made of at least one inorganic material like a ceramic or at least one organic polymer.

Examples of inorganic materials are clays, silicates, silicon carbide, aluminium oxide, zirconium oxide or graphite. Such membranes made of inorganic materials are normally made by applying pressure or by sintering of finely ground powder. Membranes made of inorganic materials may be composite membranes comprising two, three or more layers.

In one embodiment, membranes made from inorganic materials comprise a macroporous support layer, optionally an intermediate layer and a separation layer.

In a preferred embodiment, suitable membranes and/or the separation layer of a membrane comprise organic polymers, hereinafter referred to as polymers as the main components. A polymer shall be considered the main component of a membrane if it is comprised in said membrane or in the separation layer of said membrane in an amount of at least 50% by weight, preferably at least 60%, more preferably at least 70%, even more preferably at least 80% and particularly preferably at least 90% by weight.

Examples of suitable polymers are polyarylene ether, polysulfone, polyethersulfones (PES), polyphenylenesulfone (PPSU), polyamides (PA), polyvinylalcohol (PVA), cellulose acetate (CA), cellulose diacetate, cellulose triacetate (CTA), CA-triacetate blend, cellulose ester, cellulose nitrate, regenerated cellulose, aromatic, aromatic/aliphatic or aliphatic polyamide, aromatic, aromatic/aliphatic or aliphatic polyimide, polybenzimidazole (PBI), polybenzimidazolone (PBIL), polyacrylonitrile (PAN), polyetheretherketone (PEEK), sulfonated polyetheretherketone (SPEEK), PAN-poly(vinyl chloride) copolymer (PAN-PVC), PAN-methallyl sulfonate copolymer, poly(dimethylphenylene oxide) (PPO), polycarbonate, polyester, polytetrafluroethylene PTFE, poly(vinylidene fluoride) (PVDF), polypropylene (PP), polyelectrolyte complexes, poly(methyl methacrylate) PMMA, polydimethylsiloxane (PDMS), aromatic, aromatic/aliphatic or aliphatic polyimide urethanes, aromatic, aromatic/aliphatic or aliphatic polyamidimides, crosslinked polyimides or mixtures thereof.

Preferably, membranes according to the invention comprise polysulfones, polyethersulfones (PES), polyamides (PA), polyvinylalcohols (PVA), Cellulose Acetate (CA), Cellulose Triacetate (CTA) Poly(vinylidene fluoride) (PVDF) or mixtures thereof as main components.

Suitable polyethersulfones can for example be obtained from BASF SE under the brand name Ultrason®.

Preferred polyarylene ether sulfones (A) are composed of units of the general formula I

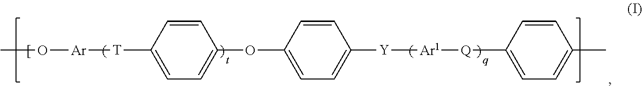

where the definitions of the symbols t, q, Q, T, Y, Ar and Ar¹ are as follows:
t, q: independently of one another 0, 1, 2, or 3,
Q, T, Y: independently of one another in each case a chemical bond or group selected from —O—, —S—, —SO₂—, S═O, C═O, —N═N—, and —CR^{a}R^{b}—, where R^{a} and R^{b} independently of one another are in each case a hydrogen atom or a C₁-C₁₂-alkyl, C₁-C₁₂-alkoxy, or C₆-C₁₈-aryl group, and where at least one of Q, T, and Y is —SO₂—, and
Ar and Ar¹: independently of one another an arylene group having from 6 to 18 carbon atoms.

If, within the abovementioned preconditions, Q, T or Y is a chemical bond, this then means that the adjacent group on the left-hand side and the adjacent group on the right-hand side are present with direct linkage to one another via a chemical bond.

However, it is preferable that Q, T, and Y in formula I are selected independently of one another from —O— and —SO₂—, with the proviso that at least one of the group consisting of Q, T, and Y is —SO₂—.

If Q, T, or Y is —CR^{a}R^{b}—, R^{a} and R^{b} independently of one another are in each case a hydrogen atom or a C₁-C₁₂-alkyl, C₁-C₁₂-alkoxy, or C₆-C₁₈-aryl group.

Preferred C₁-C₁₂-alkyl groups comprise linear and branched, saturated alkyl groups having from 1 to 12 carbon atoms. The following moieties may be mentioned in particular: C₁-C₆-alkyl moiety, e.g. methyl, ethyl, n-propyl, isopropyl, n-butyl, sec-butyl, 2- or 3-methylpentyl, and longer chain moieties, e.g. unbranched heptyl, octyl, nonyl, decyl, undecyl, lauryl, and the singly branched or multibranched analogs thereof.

Alkyl moieties that can be used in the abovementioned C₁-C₁₂-alkoxy groups that can be used are the alkyl groups defined at an earlier stage above having from 1 to 12 carbon atoms. Cycloalkyl moieties that can be used with preference in particular comprise C₃-C₁₂-cycloalkyl moieties, e.g. cyclopropyl, cyclobutyl, cyclopentyl, cyclohexyl, cycloheptyl, cyclooctyl, cyclopropylmethyl, cyclopropylethyl, cyclopropylpropyl, cyclobutylmethyl, cyclobutylethyl, cyclopentylethyl, -propyl, -butyl, -pentyl, -hexyl, cyclohexylmethyl, -dimethyl, and -trimethyl.

Ar and Ar¹ are independently of one another a C₆-C₁₈-arylene group. On the basis of the starting materials described at a later stage below, it is preferable that Ar derives from an electron-rich aromatic substance that is very susceptible to electrophilic attack, preferably selected from the group consisting of hydroquinone, resorcinol, dihydroxynaphthalene, in particular 2,7-dihydroxynaphthalene, and 4,4′-bisphenol. Ar¹ is preferably an unsubstituted C₆- or C₁₂-arylene group.

Particular C₆-C₁₈-arylene groups Ar and Ar¹ that can be used are phenylene groups, e.g. 1,2-, 1,3-, and 1,4-phenylene, naphthylene groups, e.g. 1,6-, 1,7-, 2,6-, and 2,7-naphthylene, and also the arylene groups that derive from anthracene, from phenanthrene, and from naphthacene.

In the preferred embodiment according to formula I, it is preferable that Ar and Ar¹ are selected independently of one another from the group consisting of 1,4-phenylene, 1,3-phenylene, naphthylene, in particular 2,7-dihydroxynaphthylene, and 4,4′-bisphenylene.

Preferred polyarylene ether sulfones (A) are those which comprise at least one of the following repeat units Ia to Io:

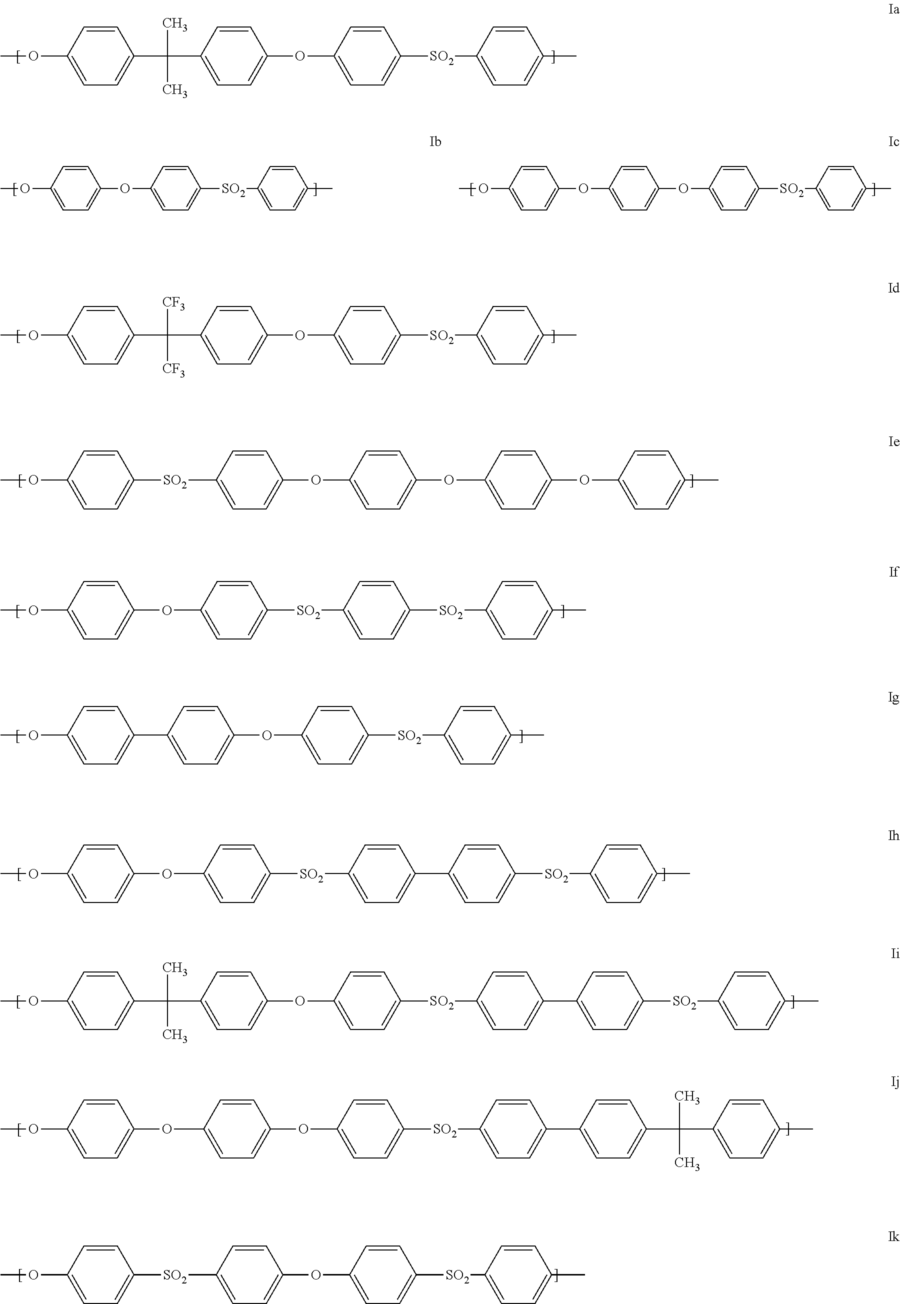

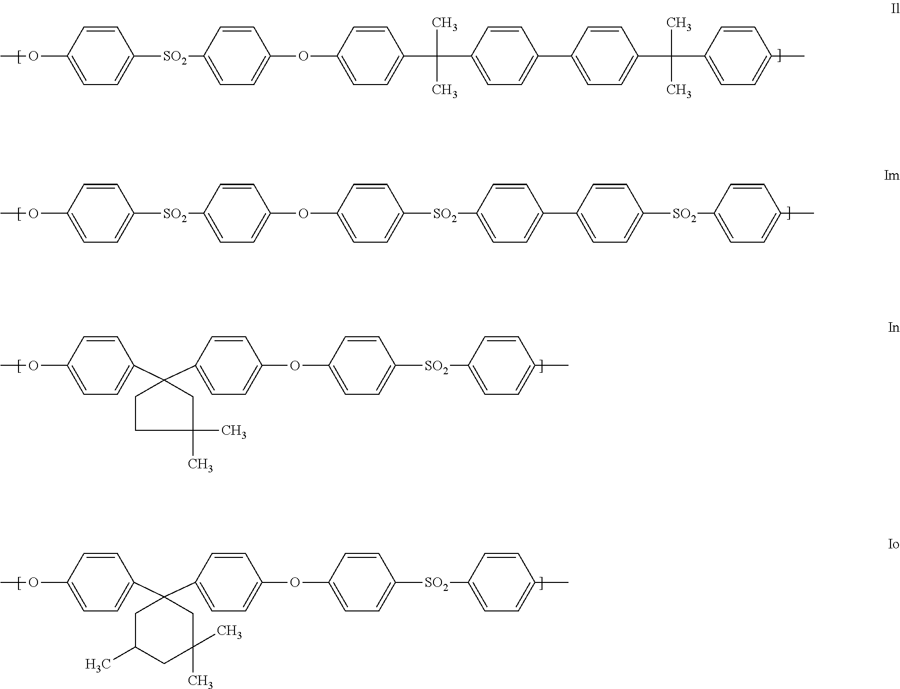

Other preferred units, in addition to the units Ia to Io that are preferably present, are those in which one or more 1,4-phenylene units deriving from hydroquinone have been replaced by 1,3-phenylene units deriving from resorcinol, or by naphthylene units deriving from dihydroxynaphthalene.

Particularly preferred units of the general formula I are the units Ia, Ig, and Ik. It is also particularly preferable that the polyarylene ether sulfones of component (A) are in essence composed of one type of unit of the general formula I, in particular of one unit selected from Ia, Ig, and Ik.

In one particularly preferred embodiment, Ar=1,4-phenylene, t=1, q=0, T is a chemical bond, and Y═SO₂. Particularly preferred polyarylene ether sulfones (A) composed of the abovementioned repeat unit are termed polyphenylene sulfone (PPSU) (formula Ig).

In another particularly preferred embodiment, Ar=1,4-phenylene, t=1, q=0, T=C(CH₃)₂, and Y═SO₂. Particularly preferred polyarylene ether sulfones (A) composed of the abovementioned repeat unit are termed polysulfone (PSU) (formula Ia).

In another particularly preferred embodiment, Ar=1,4-phenylene, t=1, q=0, T=Y═SO₂. Particularly preferred polyarylene ether sulfones (A) composed of the abovementioned repeat unit are termed polyether sulfone (PESU or PES) (formula Ik). This embodiment is very particularly preferred.

For the purposes of the present invention, abbreviations such as PPSU, PESU, and PSU are in accordance with DIN EN ISO 1043-1:2001.

The weight-average molar masses M_{w} of the polyarylene ether sulfones (A) of the present invention are preferably from 10 000 to 150 000 g/mol, in particular from 15 000 to 120 000 g/mol, particularly preferably from 18 000 to 100 000 g/mol, determined by means of gel permeation chromatography in dimethylacetamide as solvent against narrowly-distributed polymethyl methacrylate as standard.

In one embodiment of the invention, suitable polyarylene ether sulfones, particularly polysulfones or polyethersulfones comprise sulfonic acids, carboxylic acid, amino and/or hydroxy groups on some or all of the aromatic rings in the polymer.

Production processes that lead to the abovementioned polyarylene ethers are known to the person skilled in the art and are described by way of example in Herman F. Mark, “Encyclopedia of Polymer Science and Technology”, third edition, volume 4, 2003, chapter “Polysulfones” pages 2 to 8, and also in Hans R. Kricheldorf, “Aromatic Polyethers” in: Handbook of Polymer Synthesis, second edition, 2005, pages 427 to 443.

Suitable membranes are for example membranes suitable as reverse osmosis (RO) membranes, forward osmosis (FO) membranes, nanofiltration (NF) membranes, ultrafiltration (UF) membranes or microfiltration (MF) membranes. These membrane types are generally known in the art.

Suitable membranes are for example those disclosed in US 2011/0027599 in [0021] to [0169]; US 2008/0237126 in col 4, In 36 to col 6, In 3; US 2010/0224555 in [0147] to [0490]; US 2010/0062156 in [0058] to [0225]; US 2011/0005997 in [0045] to [0390], US 2009/0272692 in [0019] to [0073], US 2012/0285890 in [0016] to [0043]; these documents are incorporated herein by reference.

Further suitable membranes are for example those disclosed in U.S. Pat. No. 6,787,216, col. 2, In 54 to col 6, In 19; U.S. Pat. No. 6,454,943, col. 3; In 25 to col. 6, In 12; and WO 2006/012920, p. 3, last paragraph to p. 10, first paragraph.

FO membranes are normally suitable for treatment of seawater, brackish water, sewage or sludge streams. Thereby pure water is removed from those streams through a FO membrane into a so called draw solution on the back side of the membrane having a high osmotic pressure. Typically, FO type membranes, similar as RO membranes are separating liquid mixtures via a solution diffusion mechanism, where only water can pass the membrane whereas monovalent ions and larger components are rejected.

In a preferred embodiment, suitable FO membranes are thin film composite (TFC) FO membranes. Preparation methods and use of thin film composite membranes are principally known and, for example described by R. J. Petersen in Journal of Membrane Science 83 (1993) 81-150.

In a further preferred embodiment, suitable FO membranes comprise a support layer, a separation layer and optionally a protective layer. Said protective layer can be considered an additional coating to smoothen and/or hydrophilize the surface.

Said fabric layer can for example have a thickness of 10 to 500 μm. Said fabric layer can for example be a woven or nonwoven, for example a polyester nonwoven.

Said support layer of a TFC FO membrane normally comprises pores with an average pore diameter of for example 0.5 to 100 nm, preferably 1 to 40 nm, more preferably 5 to 20 nm. Said support layer can for example have a thickness of 5 to 1000 μm, preferably 10 to 200 μm. Said support layer may for example comprise a main component a polysulfone, polyethersulfone, polyphenylenesulfone (PPSU), PVDF, polyimide, polyimideurethane or cellulose acetate. Nano particles such as zeolites, particularly zeolite LTA, may be comprised in said support membrane. This can for example be achieved by including such nano particles in the dope solution for the preparation of said support layer.

Said separation layer can for example have a thickness of 0.05 to 1 μm, preferably 0.1 to 0.5 μm, more preferably 0.15 to 0.3 μm. Preferably, said separation layer can for example comprise polyamide or cellulose acetate as the main component.

Optionally, TFC FO membranes can comprise a protective layer with a thickness of 30-500 nm, preferably 100-300 nm. Said protective layer can for example comprise polyvinylalcohol (PVA) as the main component. In one embodiment, the protective layer comprises a halamine like chloramine.

In one preferred embodiment, suitable membranes are TFC FO membranes comprising a support layer comprising polyethersulfone as main component, a separation layer comprising polyamide as main component and optionally a protective layer comprising polyvinylalcohol as the main component.

In a preferred embodiment suitable FO membranes comprise a separation layer obtained from the condensation of a polyamine and a polyfunctional acyl halide. Said separation layer can for example be obtained in an interfacial polymerization process.

RO membranes are normally suitable for removing molecules and ions, in particular monovalent ions. Typically, RO membranes are separating mixtures based on a solution/diffusion mechanism.

In a preferred embodiment, suitable membranes are thin film composite (TFC) RO membranes. Preparation methods and use of thin film composite membranes are principally known and, for example described by R. J. Petersen in Journal of Membrane Science 83 (1993) 81-150.

In a further preferred embodiment, suitable RO membranes comprise a fabric layer, a support layer, a separation layer and optionally a protective layer. Said protective layer can be considered an additional coating to smoothen and/or hydrophilize the surface

Said fabric layer can for example have a thickness of 10 to 500 μm. Said fabric layer can for example be a woven or nonwoven, for example a polyester nonwoven.

Said support layer of a TFC RO membrane normally comprises pores with an average pore diameter of for example 0.5 to 100 nm, preferably 1 to 40 nm, more preferably 5 to 20 nm. Said support layer can for example have a thickness of 5 to 1000 μm, preferably 10 to 200 μm. Said support layer may for example comprise a main component a polysulfone, polyethersulfone, PVDF, polyimide, polyimideurethane or cellulose acetate. Nano particles such as zeolites, particularly zeolite LTA, may be comprised in said support membrane. This can for example be achieved by including such nano particles in the dope solution for the preparation of said support layer.

Said separation layer can for example have a thickness of 0.02 to 1 μm, preferably 0.03 to 0.5 μm, more preferably 0.05 to 0.3 μm. Preferably, said separation layer can for example comprise polyamide or cellulose acetate as the main component.

Optionally, TFC RO membranes can comprise a protective layer with a thickness of 5 to 500 preferable 10 to 300 nm. Said protective layer can for example comprise polyvinylalcohol (PVA) as the main component. In one embodiment, the protective layer comprises a halamine like chloramine.

In one preferred embodiment, suitable membranes are TFC RO membranes comprising a nonwoven polyester fabric, a support layer comprising polyethersulfone as main component, a separation layer comprising polyamide as main component and optionally a protective layer comprising polyvinylalcohol as the main component.

In a preferred embodiment suitable RO membranes comprise a separation layer obtained from the condensation of a polyamine and a polyfunctional acyl halide. Said separation layer can for example be obtained in an interfacial polymerization process.

Suitable polyamine monomers can have primary or secondary amino groups and can be aromatic (e.g. a diaminobenzene, a triaminobenzene, m-phenylenediamine, p-phenylenediamine, 1,3,5-triaminobenzene, 1,3,4-triaminobenzene, 3,5-diaminobenzoic acid, 2,4-diaminotoluene, 2,4-diaminoanisole, and xylylenediamine) or aliphatic (e.g. ethylenediamine, propylenediamine, piperazine, and tris(2-diaminoethyl)amine).

Suitable polyfunctional acyl halides include trimesoyl chloride (TMC), trimellitic acid chloride, isophthaloyl chloride, terephthaloyl chloride and similar compounds or blends of suitable acyl halides. As a further example, the second monomer can be a phthaloyl halide.

In one embodiment of the invention, a separation layer of polyamide is made from the reaction of an aqueous solution of meta-phenylene diamine (MPD) with a solution of trimesoyl chloride (TMC) in an apolar solvent.

In another embodiment of the invention, the separation layer and optionally other layers of the membrane contain nanoparticles other than of vanadium pentoxide. Suitable nanoparticles normally have an average particle size of 1 to 1000 nm, preferably 2 to 100 nm, determined by dynamic light scattering. Suitable nanoparticles can for example be zeolites, silica, silicates or aluminium oxide. Examples of suitable nanoparticles include Aluminite, Alunite, Ammonia Alum, Altauxite, Apjohnite, Basaluminite, Batavite, Bauxite, Beideilite, Boehmite, Cadwaladerite, Cardenite, Chalcoalumite, Chiolite, Chloraluminite, Cryolite, Dawsonite, Diaspore, Dickite, Gearksutite, Gibbsite, Hailoysite, Hydrobasaluminite, Hydrocalumite, Hydrotalcite, Illite, Kalinite, Kaolinite, Mellite, Montmoriilonite, Natroalunite, Nontronite, Pachnolite, Prehnite, Prosopite, Ralstonite, Ransomite, Saponite, Thomsenolite, Weberite, Woodhouseite, and Zincaluminit, kehoeite, pahasapaite and tiptopite; and the silicates: hsianghualite, lovdarite, viseite, partheite, prehnite, roggianite, apophyllite, gyrolite, maricopaite, okenite, tacharanite and tobermorite.

Nanoparticles may also include a metallic species such as gold, silver, copper, zinc, titanium, iron, aluminum, zirconium, indium, tin, magnesium, or calcium or an alloy thereof or an oxide thereof or a mixture thereof. They can also be a nonmetallic species such as Si3N4, SiC, BN, B4C, or TIC or an alloy thereof or a mixture thereof. They can be a carbon-based species such as graphite, carbon glass, a carbon cluster of at least C˜, buckminsterfullerene, a higher fullerene, a carbon nanotube, a carbon nanoparticle, or a mixture thereof.

In yet another embodiment the separation layer and optionally other layers of the membrane contain zeolites, zeolite precursors, amorphous aluminosilicates or metal organic frame works (MOFs) any preferred MOFs. Preferred zeolites include zeolite LTA, RHO, PAU, and KFI. LTA is especially preferred.

Preferably, the nanoparticles other than vanadium pentoxide comprised in the membrane have a polydispersity of less than 3.

In another embodiment of the invention the separation layer of the membrane contains a further additive increasing the permeability of the RO membrane. Said further additive can for example be a metal salt of a beta-diketonate compound, in particular an acetoacetonate and/or an at least partially fluorinated beta-diketonate compound.

NF membranes are normally especially suitable for removing separate multivalent ions and large monovalent ions. Typically, NF membranes function through a solution/diffusion or/and filtration-based mechanism.

NF membranes are normally used in cross filtration processes.

NF membranes can for example comprise as the main component polyarylene ether, polysulfone, polyethersulfones (PES), polyphenylensulfone (PPSU), polyamides (PA), polyvinylalcohol (PVA), Cellulose Acetate (CA), Cellulose Triacetate (CTA), CA-triacetate blend, Cellulose ester, Cellulose Nitrate, regenerated Cellulose, aromatic, aromatic/aliphatic or aliphatic Polyamide, aromatic, aromatic/aliphatic or aliphatic Polyimide, Polybenzimidazole (PBI), Polybenzimidazolone (PBIL), polyetheretherketone (PEEK), sulfonated polyetheretherketone (SPEEK), Polyacrylonitrile (PAN), PAN-poly(vinyl chloride) copolymer (PAN-PVC), PAN-methallyl sulfonate copolymer, Polysulfone, Poly(dimethylphenylene oxide) (PPO), Polycarbonate, Polyester, Polytetrafluroethylene PTFE, Poly(vinylidene fluoride) (PVDF), Polypropylene (PP), Polyelectrolyte complexes, Poly(methyl methacrylate) PMMA, Polydimethylsiloxane (PDMS), aromatic, aromatic/aliphatic or aliphatic polyimide urethanes, aromatic, aromatic/aliphatic or aliphatic polyamidimides, crosslinked polyimides or mixtures thereof. In a preferred embodiment, said main components of NF membranes are positively or negatively charged.

Nanofiltration membranes often comprise charged polymers comprising sulfonic acid groups, carboxylic acid groups and/or ammonium groups.

Preferably, NF membranes comprise as the main component polyamides, polyimides or polyimide urethanes, Polyetheretherketone (PEEK) or sulfonated polyetheretherketone (SPEEK).

UF membranes are normally suitable for removing suspended solid particles and solutes of high molecular weight, for example above 1000 Da. In particular, UF membranes are normally suitable for removing bacteria and viruses.

UF membranes normally have an average pore diameter of 0.5 nm to 50 nm, preferably 1 to 40 nm, more preferably 5 to 20 nm.

UF membranes can for example comprise as main component a polyarylene ether, polysulfone, polyethersulfones (PES), polyphenylenesulfone (PPSU), polyamides (PA), polyvinylalcohol (PVA), Cellulose Acetate (CA), Cellulose Triacetate (CTA), CA-triacetate blend, Cellulose ester, Cellulose Nitrate, regenerated Cellulose, aromatic, aromatic/aliphatic or aliphatic Polyamide, aromatic, aromatic/aliphatic or aliphatic Polyimide, Polybenzimidazole (PBI), Polybenzimidazolone (PBIL), Polyacrylonitrile (PAN), PAN-poly(vinyl chloride) copolymer (PAN-PVC), PAN-methallyl sulfonate copolymer, Polysulfone, Poly(dimethylphenylene oxide) (PPO), Polycarbonate, Polyester, Polytetrafluroethylene PTFE, Poly(vinylidene fluoride) (PVDF), Polypropylene (PP), Polyelectrolyte complexes, Poly(methyl methacrylate) PMMA, Polydimethylsiloxane (PDMS), aromatic, aromatic/aliphatic or aliphatic polyimide urethanes, aromatic, aromatic/aliphatic or aliphatic polyamidimides, crosslinked polyimides or mixtures thereof.

Preferably, UF membranes comprise as main component polysulfone, polyethersulfone, polyphenylenesulfone (PPSU), PVDF, polyimide, polyamidimide, crosslinked polyimides, polyimide urethanes or mixtures thereof.

In one embodiment, UF membranes comprise further additives like polyvinyl pyrrolidones.

In one embodiment, UF membranes comprise further additives like blockcopolymers of polyarylene sulfones and alkyleneoxides like polyethyleneoxide.

In a preferred embodiment, UF membranes comprise as major components polysulfones or polyethersulfone in combination with further additives like polyvinylpyrrolidone.

In one preferred embodiment, UF membranes comprise 80 to 50% by weight of polyethersulfone and 20 to 50% by weight of polyvinylpyrrolidone.

In another embodiment UF membranes comprise 95 to 80% by weight of polyethersulfone and 5 to 15% by weight of polyvinylpyrrolidone.

In another embodiment UF membranes comprise 99.9 to 80% by weight of polyethersulfone and 0.1 to 20% by weight of polyvinylpyrrolidone.

In one embodiment of the invention, UF membranes are present as spiral wound membranes.

In another embodiment of the invention, UF membranes are present as tubular membranes.

In another embodiment of the invention, UF membranes are present as flat sheet membranes.

In another embodiment of the invention, UF membranes are present as hollow fiber membranes.

In yet another embodiment of the invention, UF membranes are present as single bore hollow fiber membranes.

In yet another embodiment of the invention, UF membranes are present as multi bore hollow fiber membranes.

MF membranes are normally suitable for removing particles with a particle size of 0.1 μm and above.

MF membranes normally have an average pore diameter of 0.1 μm to 10 μm, preferably 1.0 μm to 5 μm.

Microfiltration can use a pressurized system but it does not need to include pressure.

MF membranes can be hollow fibers, flat sheet, tubular, spiral wound, hollow fine fiber or track etched. They are porous and allow water, monovalent species (Na+, Cr), dissolved organic matter, small colloids and viruses through while retaining particles, sediment, algae or large bacteria.

Microfiltration systems are designed to remove suspended solids down to 0.1 micrometres in size, in a feed solution with up to 2-3% in concentration.

MF membranes can for example comprise as main component polyarylene ether, polysulfone, polyethersulfones (PES), polyphenylenesulfone (PPSU), polyamides (PA), polyvinylalcohol (PVA), Cellulose Acetate (CA), Cellulose Triacetate (CTA), CA-triacetate blend, Cellulose ester, Cellulose Nitrate, regenerated Cellulose, aromatic, aromatic/aliphatic or aliphatic Polyamide, aromatic, aromatic/aliphatic or aliphatic Polyimide, Polybenzimidazole (PBI), Polybenzimidazolone (PBIL), Polyacrylonitrile (PAN), PAN-poly(vinyl chloride) copolymer (PAN-PVC), PAN-methallyl sulfonate copolymer, Polysulfone, Poly(dimethylphenylene oxide) (PPO), Polycarbonate, Polyester, Polytetrafluroethylene PTFE, Poly(vinylidene fluoride) (PVDF), Polypropylene (PP), Polyelectrolyte complexes, Poly(methyl methacrylate) PMMA, Polydimethylsiloxane (PDMS), aromatic, aromatic/aliphatic or aliphatic polyimide urethanes, aromatic, aromatic/aliphatic or aliphatic polyamidimides, crosslinked polyimides or mixtures thereof.

Suitable organoborane-amine complexes have a structure of formula (A)

R₁R₂R₃B—NR₄R₅R₆ (A),

wherein R₁, R₂ and R₃ are independently alkyl, aryl, alkoxy or aryloxy groups, with the proviso that at least one of R₁, R₂ and R₃ is an alkyl or aryl group, and
R₄, R₅ and R₆ are independently hydrogen, alkyl, cycloalkyl, substituted alkyl, alkoxy, alkylamino, aryl or heteroaryl groups, with the proviso that not more than two of R₄, R₅ and R₆ are simultaneously hydrogen, or
NR₄R₅R₆ is a heterocyclic aliphatic or aromatic amine, optionally comprising further heteroatoms selected from the group, consisting of N, O, S and P.

Organoborane-amine complexes according to formula (A) are herein also referred to as “boranes”

In a preferred embodiment of the present invention the organoborane-amine complexes are trialkylborane-amine complexes, even more preferred with R₁, R₂ and R₃ being selected from the group, consisting of methyl, ethyl, propyl, isopropyl, butyl, isobutyl and sec-butyl, most preferred with R₁, R₂ and R₃ being identical alkyl groups.

In another preferred embodiment of the present invention the amine in the organoborane-amine complexes is a primary, secondary or tertiary amine. Preferred are primary and secondary amines, even more preferred are primary amines. In another preferred embodiment of the present invention the organoborane-amine complexes comprise an amine NR₄R₅R₆, which is heterocyclic aliphatic or aromatic amine, that may contain further heteroatoms selected from the group, consisting of N, O, S and P. In another preferred embodiment of the present invention the organoborane-amine complexes comprise an amine NR₄R₅R₆, which is selected from the group, consisting of 1,2-diaminopropane, 3-methoxypropylamine, 4-dimehtylaminopyridine, 1,4-diazabicylco[2.2.2]octane, diethylenetriamine, triethylenetetraamine, propylamine, morpholine and piperidine.

As used in connection with the present invention, the term “alkyl” denotes a branched or an unbranched saturated hydrocarbon group comprising between 1 and 24 carbon atoms; examples are methyl, ethyl, propyl, isopropyl, butyl, isobutyl, sec-butyl, tert-butyl, amyl, isoamyl, sec-amyl, 1,2-dimethylpropyl, 1,1-dimethylpropyl, hexyl, 4-methylpentyl, 1-methylpentyl, 2-methylpentyl, 3-methylpentyl, 1,1-dimethylbutyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, heptyl, 5-methylhexyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethylpentyl, 1,2,3-trimethylbutyl, 1,1,2-trimethylbutyl, 1,1,3-trimethylbutyl, octyl, 6-methylheptyl, 1-methylheptyl, 1,1,3,3-tetramethylbutyl, nonyl, 1-, 2-, 3-, 4-, 5-, 6- or 7-methyloctyl, 1-, 2-, 3-, 4- or 5-ethylheptyl, 1-, 2- or 3-propylhexyl, decyl, 1-, 2-, 3-, 4-, 5-, 6-, 7- and 8-methylnonyl, 1-, 2-, 3-, 4-, 5- or 6-ethyloctyl, 1-, 2-, 3- or 4-propylheptyl, undecyl, 1-, 2-, 3-, 4-, 5-, 6-, 7-, 8- or 9-methyldecyl, 1-, 2-, 3-, 4-, 5-, 6- or 7-ethylnonyl, 1-, 2-, 3-, 4- or 5-propyloctyl, 1-, 2- or 3-butylheptyl, 1-pentylhexyl, dodecyl, 1-, 2-, 3-, 4-, 5-, 6-, 7-, 8-, 9- or 10-methylundecyl, 1-, 2-, 3-, 4-, 5-, 6-, 7- or 8-ethyldecyl, 1-, 2-, 3-, 4-, 5- or 6-propylnonyl, 1-, 2-, 3- or 4-butyloctyl, 1-2-pentylheptyl and isopinocampheyl. Preferred are the alkyl groups methyl, ethyl, propyl, isopropyl, n-butyl, isobutyl, sec-butyl, tert-butyl, amyl, isoamyl, sec-amyl, 1,2-dimethylpropyl, 1,1-dimethylpropyl, hexyl and octyl.

The term “cycloalkyl” denotes a saturated hydrocarbon group comprising between 3 and 16 carbon atoms including a mono- or polycyclic structural moiety. Examples are cyclopropyl, cyclobutyl, cyclopentyl, cyclohexyl, cycloheptyl, cyclooctyl, cyclononyl or cyclodecyl. Preferred are cyclopropyl, cyclopentyl and cyclohexyl.

The term “aryl” denotes an unsaturated hydrocarbon group comprising between 6 and 14 carbon atoms including at least one aromatic ring system like phenyl or naphthyl or any other aromatic ring system.

The term “heteroaryl” denotes a mono- or polycyclic aromatic ring system comprising between 3 and 14 ring atoms, in which at least one of the ring carbon atoms is replaced by a heteroatom like nitrogen, oxygen or sulfur. Examples are pyridyl, pyranyl, thiopyranyl, chinolinyl, isochinolinyl, acridyl, pyridazinyl, pyrimidyl, pyrazinyl, phenazinyl, triazinyl, pyrrolyl, furanyl, thiophenyl, indolyl, isoindolyl, pyrazolyl, imidazolyl, oxazolyl, isoxazolyl, thiazolyl, isothiazolyl and triazolyl.

The term “alkoxy” denotes an —Oalkyl group derived from an aliphatic monoalcohol. The term “aryloxy” denotes an —Oaryl group derived from an aromatic monoalcohol. The term “alkylamino” denotes an alkyl group in which at least one hydrogen atom has been replaced by a —NR₄R₅ group.

The alkylborane-amine complexes can be applied on the membrane neat or in solution with a solvent. Polar (e.g. THF, dioxane, alcohols) and non-polar (hydrocarbons like hexanes, pentanes, heptanes, aromatic hydrocarbons, like toluene, benzene, xylene, ethers like diethylether) solvents can be used for that purpose. Preferred are non-polar solvents. In a preferred embodiment of the present invention the alkylborane-amine complexes is applied in solution at a concentration in the range of from 0.01 to 60% (v/v), more preferably in the range of from 0.5 to 30% (v/v).

Membranes according to the invention comprise a coating that has been grafted on the surface of a base membrane. Said coating can also be described as a modified surface. Said coating can bind to the surface of the base membrane through adhesion or, preferably, through covalent bonds with the surface of the base membrane.

Said coating can be a monomer, oligomer or polymer. Said coating can be crosslinked or not be crosslinked.

A “monomer”, for example “biocidal monomers”, “antiadhesive monomers” or “radically polymerizable monomers”, in this application shall, depending on the context, refer to such monomer in unpolymerized (monomeric) form or in polymerized form. When the term “monomer” is for example used in the context of a formulation, it normally refers to the unpolymerized form. When the term “monomer” is for example used in the context of a polymer or a coating, it normally refers to the polymerized form, in which said monomer is comprised in the polymer or coating.

Said coating is obtained from a composition comprising at least one radically polymerizable compound.

A radically polymerizable monomer compound is to be understood as a monomer that is able to undergo a radical polymerization reaction. These are for example compounds with a structure of formula (2) comprising an olefinic double bond

R₇R₈C═CR₉R₁₀ (2),

or with a structure of formula (3) comprising an acetylenic triple bond

R₇C≡CR₈ (3),

or with a structure of formula (4) comprising a carbonyl group

R₇R₈C═O (4),

or with a structure of formula (5) comprising a carbon nitrogen double bond

R₇R₈C═NR₉ (5),

wherein R₇, R₈, R₉ and R₁₀ are independently for example hydrogen, alkyl, cycloalkyl, substituted alkyl, aralkyl, alkaryl, alkoxy, aryloxy, alkylamino, aryl or heteroaryl, carbonyl, carboxyl, amide, ester or nitrile groups.

The term “substituted alkyl” denotes an alkyl group in which at least one hydrogen atom is replaced by a halide atom like fluorine, chlorine, bromine or iodine or by a heteroatom, e.g. boron, silicon, nitrogen, phosphorus, oxygen, sulphur or by a protected or unprotected functional group like alkoxy, amino, ammonium, ester, amide, nitrile, carbonyl, carboxyl etc..

The term “aralkyl” denotes an aryl-substituted alkyl group including for example benzyl, 1- or 2-phenylethyl, 1-, 2- or 3-phenylpropyl, mesityl and 2-, 3- or 4-methylbenzyl groups.

The term “alkaryl” denotes an alkyl-substituted aryl group including for example 2-, 3- or 4-methylphenyl, 2-, 3- or 4-ethylphenyl and 2-, 3-, 4-, 5-, 6-, 7- or 8-methyl-1-naphthyl groups.

In a preferred embodiment, said at least one radically polymerizable compound is a monomer that imparts flux enhancing properties to the membrane. Monomers that impart flux enhancing properties to the membrane are herein also referred to as “flux enhancing monomers”. The term “flux” shall denote the flux of the medium that is subjected to a separation operation through the membrane. In many cases, “flux” means the flux of water through the membrane. For example in the case of water treatment applications, “flux” means the amount of water that permeates through the specified membrane area in a certain period of time.

In the context of this application, “improving the flux” shall also be understood to mean “reducing the decrease of flux through a membrane over time”.

Flux enhancing properties in the context of this invention refer in particular to the long term properties of membranes. While it is possible that through the application of a coating the flux may decrease over a short term, the flux over the long term will be improved, meaning that the decrease of flux is reduced relative to a membrane to that no such coating has been applied. The duration of a “short term” or “long term” may vary depending on the membrane or the application or the material subjected to that application, that is for example from the type of water treated. Thus, enhancing of flux in the context of this application shall mean that after at least one certain period of time and under at least one set of application conditions, the flux of a membrane according to the invention shall be improved or the decrease of flux be reduced over the flux of a membrane comprising no coating according to this invention or over membranes known from the art. For example, membranes according to the invention may show improved flux over prior art membranes after a period of 1 hour, 1 day, 3 days, 5 days, 1 week, 2 weeks, three weeks, one month, two months, three months, six months and/or one year. Sometimes the enhanced flux of membranes according to the invention only becomes observable after one or a certain number of cleaning cycles have been applied to the membrane.

It is also possible the membranes according to the invention show improved properties with respect to their ability to restore the flux after cleaning. Also membranes according to the invention can be easier to clean. Furthermore less cleaning agents may be requires for cleaning membranes according to the invention.

In particular, suitable flux enhancing monomers reduce fouling and in particular biofouling of the membrane.

In the context of this application, an effect of a polymer or the coating comprising a flux enhancing monomer is also sometimes referred to as the effect of the flux enhancing monomer. Monomers bearing a charge, for example from ammonium groups or carboxylate groups, are accompanied by one or more counterions. If, in this application, a monomer bearing a charge is depicted or named without corresponding counterion, such monomers are to be understood to be accompanied by a suitable counterion (with the exception of betaines). Such counterions are for example chloride, bromide, iodide, carboxylates for monomers bearing a positive charge. For monomers bearing negative charge, suitable counterions are for example sodium, potassium, magnesium, calcium, ammonium.

Said coating is obtained by treating the surface of a base membrane that has been treated with a suitable borane as described above with at least one flux enhancing monomer.

In a preferred embodiment, suitable flux enhancing monomers are antiadhesive monomers or biocidal monomers that impart biocidal and/or antiadhesive properties to the membrane.

An antiadhesive monomer in the context of this application shall mean a monomer that imparts antiadhesive properties to the coating, be it by itself or in combination with other components. Antiadhesive properties or antiadhesive coating means that for example particles or biological material or biological organisms or degradation products of biological material or biological organisms have a lower tendency to adhere to the surface of a membrane having such antiadhesive properties. The degree of fouling and in particular biofouling of a membrane is thus reduced.

Antiadhesive coatings are sometimes also referred to as anti-sticking coatings, ‘stealth’ coatings or biopassive coatings.

The concept of antiadhesive polymers and coatings is for example disclosed in the following pieces of literature, which are incorporated herein by reference:
R. Konradi et al. Macromol. Rapid Commun. 2012, 33, 1663-1676;
R. G. Chapman, E. Ostuni, M. N. Liang, G. Meluleni, E. Kim, L. Yan, G. Pier, H. S. Warren, G. M. Whitesides, Langmuir 2001, 17, 1225;
R. G. Chapman, E. Ostuni, S. Takayama, R. E. Holmlin, L. Yan, G. M. Whitesides, J. Am. Chem. Soc. 2000, 122, 8303;
E. Ostuni, R. G. Chapman, R. E. Holmlin, S. Takayama, G. M. Whitesides, Langmuir 2001, 17, 5605;
E. Ostuni, R. G. Chapman, M. N. Liang, G. Meluleni, G. Pier, D. E. Ingber, G. M. Whitesides, Langmuir 2001, 17, 6336.

In one embodiment of the invention, suitable antiadhesive monomers are those, whose polymerization leads to the formation of antiadhesive coatings that are characterized by the presence of hydrophilic groups and preferentially the presence of hydrogen-bond-accepting groups, preferentially the absence of hydrogen-bond donating groups and preferentially the absence of net charge.

Suitable antiadhesive monomers are for example selected from
a) esters of (meth)acrylic acid with polyols
b) vinyl ethers of polyols
c) hydrophilic macromonomers different from monomers a) and b)
d) N-vinyl compounds
e) Low molecular weight hydrophilic (meth)acrylamides
f) (meth)acrylates or (meth)acrylamides bearing epoxy groups
g) monomers having a betain structure
h) hydrophilic monomers different from those mentioned under a) to g).
i) Ion pair comonomers

Suitable esters of (meth)acrylic acid with polyols a) are preferably esters with polyols that are hydrophilic and with which coatings can be prepared that show antiadhesive properties as described above.

In one embodiment, suitable esters of (meth)acrylic acid with polyols are polyols, in which each OH group is esterified with (meth)acrylic acid.

In one embodiment, suitable esters of (meth)acrylic acid with polyols are polyols, in which at least one OH group is esterified with (meth)acrylic acid and at least one OH group is not esterified.

In one embodiment, suitable esters of (meth)acrylic acid with polyols are polyols, in which at least one OH group is esterified with (meth)acrylic acid and at least one OH group is etherified with an alcohol like methanol, ethanol, propanol or a polyol like ethyleneglycol, neopentylglycol, trimethylolpropane, glycerol, trimethylolethane, pentaerythritol or dipentaerythritol, (poly)saccharide, in particular sorbitol.

Examples of suitable esters of (meth)acrylic acid with polyols are for example (meth)acrylates of alkoxylated polyols like ethyleneglycol, neopentylglycol, trimethylolpropane, glycerol, trimethylolethane, pentaerythritol, dipentaerythritol, or (poly)saccharide, in particular sorbitol bearing 1 to 100, preferably 1 to 50 ethoxy, propoxy, mixed ethoxy and propoxy, more preferably exclusively ethoxy groups per OH-group of the polyol.

More Preferably, suitable esters of (meth)acrylic acid with polyols are (meth)acrylates of, with respect to each OH group of the polyol, singly to hundred-fold, more preferably triply to 50-fold, in particular triply to vigintuply (20-fold) ethoxylated, propoxylated or mixedly ethoxylated and propoxylated, and more particularly exclusively ethoxylated, neopentylglycol, trimethylolpropane, glycerol, trimethylolethane, pentaerythritol, dipentaerythritol, or (poly)saccharide, in particular sorbitol.

Particularly preferred esters of (meth)acrylic acid with polyols are
ethylene glycol di(meth)acrylate, diethylene glycol di(meth)acrylate, triethylene glycol di(meth)acrylate, oligoethylene glycol di(meth)acrylate, polyethylene glycol di(meth)acrylate,
ethylene glycol mono(meth)acrylate, diethylene glycol mono(meth)acrylate, triethylene glycol mono(meth)acrylate, oligoethylene glycol mono(meth)acrylate, polyethylene glycol mono(meth)acrylate,
Ethylene glycol methyl ether (meth)acrylate, di(ethylene glycol) methyl ether (meth)acrylate, tri(ethylene glycol) methyl ether (meth)acrylate, oligo(ethylene glycol) methyl ether (meth)acrylate, poly(ethylene glycol) methyl ether (meth)acrylate,
glycerol tri(meth)acrylate, glycerol alkoxylate tri(meth)acrylate, preferentially glycerol ethoxylate tri(meth)acrylate
trimethylolpropane tri(meth)acrylate, trimethylolpropane alkoxylate tri(meth)acrylate, preferentially trimethylolpropane ethoxylate tri(meth)acrylate
pentaerythritol tetra(meth)acrylate, pentaerythritol alkoxylate tetra(meth)acrylate, preferentially pentaerythritol ethoxylate tetra(meth)acrylate
pentaerythritol tri(meth)acrylate, pentaerythritol alkoxylate tri(meth)acrylate, preferentially pentaerythritol ethoxylate tri(meth)acrylate
dipentaerythritol penta(meth)acrylate, dipentaerythritol alkoxylate penta(meth)acrylate, preferentially dipentaerythritol ethoxylate penta(meth)acrylate
sorbitol hexa(meth)acrylate, sorbitol alkoxylate hexa(meth)acrylate, preferentially sorbitol ethoxylate hexa(meth)acrylate; sorbitol penta(meth)acrylate, sorbitol alkoxylate penta(meth)acrylate, preferentially sorbitol ethoxylate penta(meth)acrylate; sorbitol tetra(meth)acrylate, sorbitol alkoxylate tetra(meth)acrylate, preferentially sorbitol ethoxylate tetra(meth)acrylate; sorbitol tri(meth)acrylate, sorbitol alkoxylate tri(meth)acrylate, preferentially sorbitol ethoxylate tri(meth)acrylate.

In one embodiment, suitable esters of (meth)acrylic acid with polyols do not include (meth)acrylic esters with polyalkyleneoxides like polyethyleneoxides.

In another embodiment, suitable esters of (meth)acrylic acid with polyols do not include esters of acrylic aid with polyvalent alcohols or phenols.

Suitable antiadhesive monomers b) are vinyl ethers of polyols or vinyl ethers of alkoxylated polyols.

Suitable vinyl ethers of polyols are preferably ethers with that are hydrophilic and with which coatings can be prepared that show antiadhesive properties as described above.

In one embodiment, suitable vinyl ethers of polyols are polyols, in which each OH group is etherified vinyl alcohol.

In one embodiment, suitable vinyl ethers of polyols are polyols, in which at least one OH group is etherified with vinyl alcohol and at least one OH group is not etherified.

In one embodiment, suitable vinyl ethers of polyols are polyols, in which at least one OH group is etherified vinylalcohol and at least one OH group is etherified with a saturated alcohol like methanol, ethanol, propanol or a polyol like ethyleneglycol, neopentylglycol, trimethylolpropane, glycerol, trimethylolethane, pentaerythritol, dipentaerythritol, (poly)saccharide like sorbitol.

Examples of suitable vinyl ethers of polyols are for example vinyl ethers of alkoxylated polyols like ethyleneglycol, neopentylglycol, trimethylolpropane, glycerol, trimethylolethane, pentaerythritol or dipentaerythritol bearing 1 to 100, preferably 1 to 50 ethoxy, propoxy, mixed ethoxy and propoxy, more preferably exclusively ethoxy groups per OH-group of the polyol.

Preferred vinyl ethers of polyols are ethylene glycol divinylether, diethylene glycol divinylether, triethylene glycol divinylether, oligoethylene glycol divinylether, polyethylene glycol divinyl ether, methoxyethylene glycol monovinylether, methoxy diethylene glycol monovinylether, methoxy triethylene glycol monovinylether, methoxy oligoethylene glycol monovinylether, methoxy polyethylene glycol monovinyl ether.

Suitable antiadhesive monomers c) are hydrophilic macromonomers such as (meth)acryloyl-, (meth)acrylamide- and vinylether-modified hydrophilic polymers, preferentially (meth)acryloyl-modified polyvinyl alcohol, (meth)acryloyl-modified partially hydrolyzed polyvinyl acetate, (meth)acryloyl-modified poly(2-alkyl-2-oxazoline), (meth)acrylamide-modified poly(2-alkyl-2-oxazoline), in particular (meth)acryloyl and (meth)acrylamide-modified poly(2-methyl-2-oxazoline) and (meth)acryloyl- and (meth)acrylamide-modified poly(2-ethyl-2-oxazoline), (meth)acryloyl- and (meth)acrylamide-modified poly(vinyl pyrrolidone), (meth)acryloyl- and (meth)acrylamide-modified hydrophilic polypeptoids, (meth)acryloyl- and (meth)acrylamide-modified polyphosphorylcholine, (meth)acryloyl- and (meth)acrylamide-modified polysulfobetain, (meth)acryloyl- and (meth)acrylamide-modified polycarbobetain, (meth)acryloyl- and (meth)acrylamide-modified polyampholyte.

Suitable antiadhesive monomers d) are N-vinyl compounds such as N-vinyl pyrrolidone, N-vinylCaprolactam, N-vinylcaprolactone or N-vinyl-2-piperidone.

In one embodiment, monomers d) do not include N-vinyl pyrrolidone.

Suitable antiadhesive monomers e) are low molecular weight (meth)acrylamides with a molecular weight below 200, preferably below 150.

Preferred low molecular weight (meth)acrylamides are those according to formula

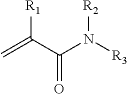

with R₁═H or CH₃, R₂, R₃=independently from each other H, methyl, ethyl, 1-propyl, 2-propyl, 1-butyl, 2-butyl.

Preferred alkylated (meth)acrylamides are: R₂═R₃═H (=(meth)acrylamide), R₂═R₃=methyl (═N,N-dimethyl(meth)acrylamide), R₂═R₃=ethyl (═N,N-diethyl(meth)acrylamide), R₂═H, R₃₌₂-propyl (═N-isopropyl(meth)acrylamide).

Suitable (meth)acrylates or (meth)acrylamides bearing epoxy groups f) are for example glycidyl (meth)acrylate.

Suitable monomers having a betain structure g) are for example sulfobetaines or carbobetaines of (meth)acrylates or (meth)acrylamides, sulfonyl- or carboxy-modified vinylimidazolium betains, sulfonyl- or carboxy-modified vinylpyridinium betains, sulfobetain- or carbobetain-modified styrenyls, phosphobetain(meth)acrylates or phosphobetain(meth)acrylamides.

Suitable sulfobetaines or carbobetaines of (meth)acrylates or (meth)acrylamides are for example sulfobetain(meth)acrylates, sulfobetain(meth)acrylamides, carbobetain(meth)acrylates, carbobetain(meth)acrylamides of general formula

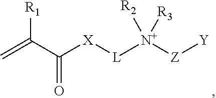

wherein
R₁═H, Methyl;
R₂, R₃=alkyl, aryl, aralkyl, preferentially R₂═R₃=Methyl;
X═O, NH;
L=alkyl, aryl, aralkyl. L may contain heteroatoms in particular one or several groups of (CH₂)ₙO, (CH₂)ₙNH, n is preferentially 2-3; preferably L is methylene, ethylene or propylene; in particular ethylene or propylene.
Z=alkyl, aryl, aralkyl. Z may contain heteroatoms in one or several groups of (CH₂)ₙO, (CH₂)ₙNH, n is preferentially 2-3; preferably Z is methylene, ethylene, propylene, butylene
Y=sulfonate or carboxylate

Examples of suitable sulfobetaines or carbobetaines of (meth)acrylates or (meth)acrylamides include:

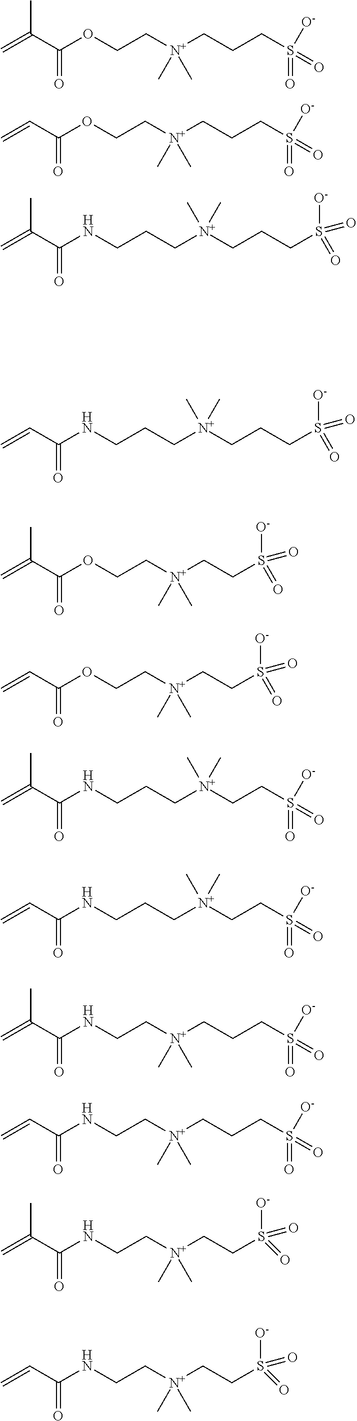

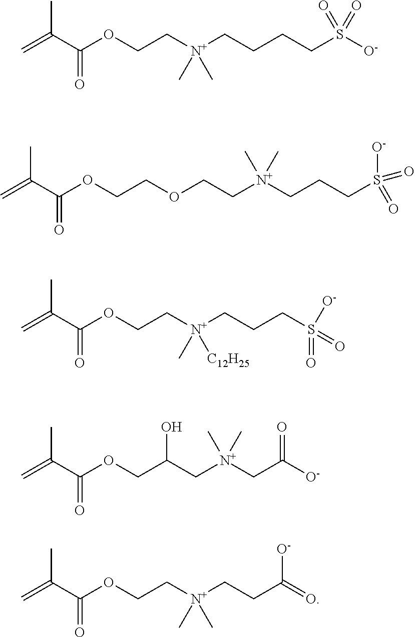

Further suitable sulfobetaines or carbobetaines of (meth)acrylates or (meth)acrylamides are sulfobetain di(meth)acrylates, sulfobetain di(meth)acrylamides, carbobetain di(meth)acrylates and carbobetain di(meth)acrylamides. Preferred sulfobetaines or carbobetaines of (meth)acrylates or (meth)acrylamides are of the general formula

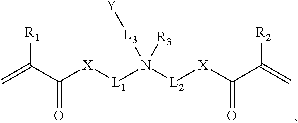

wherein
R₁, R₂═H, Methyl
R₃=alkyl, aryl, aralkyl, preferably R₃=Methyl
X═O, NH
L₁, L₂=independently from each other alkyl, aryl, aralkyl. L may contain heteroatoms in particular one or several groups of (CH₂)ₙO, (CH₂)ₙNH, n is preferentially 2-3; preferably L=methylene, ethylene, propylene; in particular ethylene and propylene;
L₃=alkyl, aryl, aralkyl. L₃ may contain heteroatoms in particular one or several groups of (CH₂)ₙO, (CH₂)ₙNH, n is preferably 2-3; preferably L₃=methylene, ethylene, propylene, butylene;
Y=sulfonate or carboxylate.

Further examples of suitable sulfobetaines or carbobetaines of (meth)acrylates or (meth)acrylamides are

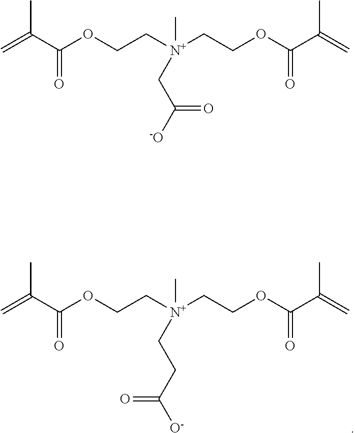

Suitable sulfonyl- or carboxy-modified vinylimidazolium betains are for example sulfonylor carboxy-modified vinylimidazolium betains of general formula

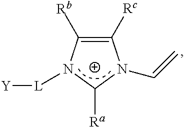

wherein
R^{a}, R^{b} and R^{c} independently of one another are an H atom or an organic radical having up to 22 C atoms, preferably R^{a}═R^{b}═R^{c}═H,
L=alkyl, aryl, aralkyl. L may contain heteroatoms in particular one or several groups of (CH₂)ₙO, (CH₂)ₙNH, n is preferentially 2-3; preferably L=methylene, ethylene, propylene, butylene,
Y=sulfonate or carboxylate.

Examples of sulfonyl- or carboxy-modified vinylimidazolium betains are:

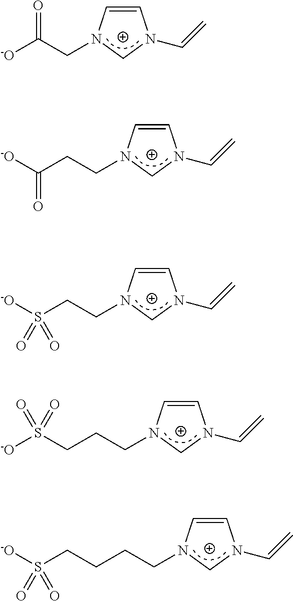

Suitable sulfonyl- or carboxy-modified vinylpyridinium betains are for example those according to the general formula

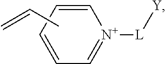

wherein
L=alkyl, aryl, aralkyl; L may contain heteroatoms in particular one or several groups of (CH₂)ₙO, (CH₂)ₙNH, n is preferably 2-3;
   preferably L=methylene, ethylene, propylene, butylene;
Y=sulfonate or carboxylate.

Examples of sulfonyl- or carboxy-modified vinylpyridinium betains include

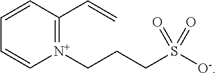

Suitable Sulfobetain- or Carbobetain-modified styrenyls are for example those according to the general formula

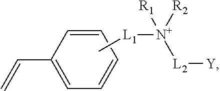

wherein
R₁, R₂=alkyl, aryl, aralkyl, preferably R₁═R₂=Methyl,
L₁, L₂=independently from each other alkyl, aryl, aralkyl; L may contain heteroatoms in particular one or several groups of (CH₂)ₙO, (CH₂)ₙNH, n is preferentially 2-3;
   preferably L=methylene, ethylene, propylene, butylene; in particular ethylene and propylene,
Y=sulfonate or carboxylate.

Examples of Sulfobetain- or Carbobetain-modified styrenyls include:

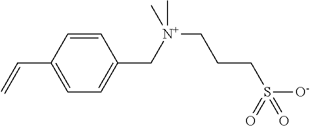 [SMILES: C=Cc1ccc(C[N+](C)(C)CCCS(=O)(=O)[O-])cc1]

Suitable phosphobetain(meth)acrylates or phosphobetain(meth)acrylamides are those of the general formula

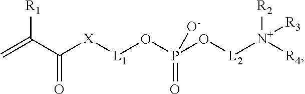

wherein

R₁═H, Methyl,

R₂, R₃, R₄=alkyl, aryl, aralkyl, preferentially R₂═R₃═R₃=Methyl,
X═O, NH,
L₁, L₂=independently from each other alkyl, aryl, aralkyl. L₁, L₂ may independently from each other contain heteroatoms in particular one or several groups of (CH₂)ₙO, (CH₂)ₙNH, n is preferably 2-3; preferably L₁, L₂ are independently from each other methylene, ethylene, propylene, butylene; in particular and independently from each other ethylene and propylene.

Examples of phosphobetain(meth)acrylates or phosphobetain(meth)acrylamides include

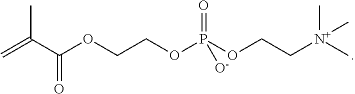 [SMILES: C=C(C)C(=O)OCCOP(=O)([O-])OCC[N+](C)(C)C]

Suitable hydrophilic monomers h) different from those mentioned above are hydroxyethyl(meth)acrylate, Vinyl alcohol, (Meth)acryloyl and (meth)acrylamide-modified mono- and oligosaccharides.

Suitable Ion pair comonomers i) are in particular ion pairs of ammonium-modified (meth)acrylates or (meth)acrylamides and sulfo-, carboxy-, phosphonyl or phosphoryl-modified (meth)acrylates or (meth)acrylamides. A preferred example is the combination

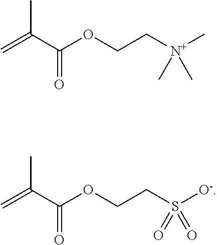

In one embodiment of the invention the coating comprises only one antiadhesive monomer.

In one embodiment of the invention the coating comprises at two or more antiadhesive monomers.

A biocidal monomer in the context of this application shall mean a monomer that imparts biocidal properties to the coating, be it by itself or in combination with other components. Biocidal properties or biocidal coating means that living biological organisms like plants, algae, bacteria, cyanobacteria, fungi, yeasts, molds, protozoa, viruses, mycoplasma, other microorganisms or higher organisms such as barnacles are deterred, controlled and/or inactivated by said coating. The degree of fouling and in particular biofouling of a membrane is thus reduced.

The mechanisms of such biocidal effects are not entirely understood. It is assumed the biocidal effect of biocidal monomers or coatings can for example be due to the interfering with the production of the bacterial plasma wall, interfering with protein synthesis, nucleic acid synthesis, or plasma membrane integrity, or to inhibiting critical biosynthetic pathways in the bacteria.

Suitable biocidal monomers are for example selected from
j) vinyl-imidazolium compounds,
k) ethylenically unsaturated monomers bearing quarternary ammonium or phosphonium groups,
l) diallyldialkylammoniumchlorides,
m) alkylaminoalkyl (meth)acrylates and alkylaminoalkyl (meth)acrylamides,
n) Polylysine (meth)acrylamides or (meth)acrylates,
o) alkyl-4-vinylpridinium and alkyl-2-vinyl-pyridinium salts, in particular bromides and iodides,
p) ethylenically unsaturated monomers bearing guanide and biguanide groups,
q) halamines.

Further biocidal monomers and corresponding polymers can be found for example in Tatsuo Tashiro Macromol. Mater. Eng. 2001, 286, 63-87.

Suitable vinyl-imidazolium compounds j) are in particular 3-vinyl-imidazol-1-ium compounds. These are preferably selected from a 3-vinyl-imidazol-1-ium compounds having the formula (III)

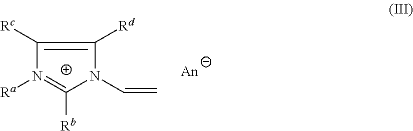

in which R^{a} is an organic radical having 1 to 22 C atoms,
R^{b}, R^{c} and R^{d} independently of one another are an H atom or an organic radical having up to 22 C atoms and An⁻ is an anion.

R^{a} is an organic radical having 1 to 22 C atoms. The organic radical may also comprise further heteroatoms, more particularly oxygen atoms, nitrogen, sulfur or phosphorus atoms, or functionnal groups, as for example hydroxyl groups, ether groups, ester groups, or carbonyl groups.

More particularly R^{a} is a hydrocarbon radical which apart from carbon and hydrogen may further comprise at most hydroxyl groups, ether groups, ester groups or carbonyl groups.

R^{a} with particular preference is a hydrocarbon radical having 1 to 22 C atoms, more particularly having 4 to 20 C atoms, which comprises no other heteroatoms, e.g., oxygen or nitrogen. The hydrocarbon radical may be aliphatic (in which case unsaturated aliphatic groups are also included, but less preferred) or aromatic, or may comprise both aromatic and aliphatic groups. Preferably R^{a} is an aliphatic hydrocarbon radical.

Examples of hydrocarbon radicals include the phenyl group, benzyl group, a benzyl group or phenyl group substituted by one or more C₁ to C₄ alkyl groups, or the mesityl group, alkyl groups and alkenyl groups, more particularly the alkyl group.

With very particular preference R^{a} is a 04 to 022 alkyl group, preferably a 04 to 018.

Examples for R^{a} are methyl, ethyl, 1-propyl, 2-propyl, 1-butyl, 2-butyl, 2-methyl-1-propyl (isobutyl), 2-methyl-2-propyl (tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, nonyl, decyl, undecyl, dodecyl, tridecyl, tetradecyl, pentadecyl, hexadecyl, heptadecyl, octadecyl, nonadecyl, icosyl, phenylmethyl (benzyl), diphenylmethyl, triphenylmethyl, 2-phenylethyl, 3-phenylpropyl, cyclopentylmethyl, 2-cyclopentylethyl, 3-cyclopentylpropyl, cyclohexylmethyl, 2-cyclohexylethyl, and 3-cyclohexylpropyl.

With very particular preference R^{a} is a 1-butyl, 2-butyl, 2-methyl-1-propyl (isobutyl), 2-methyl-2-propyl (tert-butyl), 1-pentyl, 2-pentyl, 3-pentyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, nonyl, decyl, undecyl, dodecyl, tridecyl, tetradecyl, pentadecyl, hexadecyl, heptadecyl, octadecyl, nonadecyl, or icosyl group, with the butyl, pentyl, hexyl, octyl, decyl, dodecyl, tetradecyl, hexadecyl, and octadecyl groups having particular importance.

In one preferred embodiment R^{b} is an H atom.

In another preferred embodiment R^{b} is an alkyl group, as for example a C₁ to C₁₈ alkyl group, preferably a C₁ to C₁₆, more preferably a C₁ to C₁₄, very preferably C₁ to C₁₂, and more particularly C₁ to C₁₀ alkyl group. For the radical R^{b}, a C₁ to C₆ alkyl group represents one particular embodiment, and in a very particular embodiment the alkyl group is a C₁ to C₄ alkyl group.

R^{c} and R^{d} are preferably independently of one another a hydrogen atom or an organic radical having 1 to 10 C atoms. The organic radical may also comprise further heteroatoms, more particularly oxygen atoms, nitrogen, sulfur or phosphorus atoms, or functional groups, as for example hydroxyl groups, ether groups, ester groups, or carbonyl groups.

More particularly R^{c} and R^{d} are a hydrocarbon radical which apart from carbon and hydrogen may further comprise at most hydroxyl groups, ether groups, ester groups or carbonyl groups.

R^{c} and R^{d} with particular preference are independently of one another a hydrocarbon radical having 1 to 20 C atoms, more particularly having 1 to 10 C atoms, which comprises no other heteroatoms, e.g., oxygen or nitrogen. The hydrocarbon radical may be aliphatic (in which case unsaturated aliphatic groups are also included) or aromatic, or may comprise both aromatic and aliphatic groups.

Examples of hydrocarbon radicals include the phenyl group, benzyl group, a benzyl group or phenyl group substituted by one or more C₁ to C₄ alkyl groups, or the mesityl group, alkyl groups and alkenyl groups, more particularly the alkyl group.

With very particular preference R^{c} and R^{d} are a hydrogen atom or a C₁ to C₁₀ alkyl group. A partitularly preferred alkyl group is a C₁ to C₆ alkyl group, and in one particular embodiment the alkyl group is a C₁ to C₄ alkyl group.

With very particular preference R^{c} and R^{d} are independently of one another a methyl, ethyl, n-propyl, isopropyl, n-butyl, sec-butyl or tert-butyl group, with the methyl, ethyl n-propyl, and n-butyl groups having particular importance.

In one particular embodiment R^{c} and R^{d} are each H atoms.

In a very particular embodiment R^{b}, R^{c}, and R^{d} are each H atoms.

Examples of imidazolium ions are 1-butyl-3-vinyl-imidazol-1-ium, 1-pentyl-3-vinyl-imidazol-1-ium, 1-hexyl-3-vinyl-imidazol-1-ium, 1-octyl-3-vinyl-imidazol-1-ium, 1-decyl-3-vinyl-imidazol-1-ium, 1-dodecyl-3-vinyl-imidazol-1-ium, 1-tetradecyl-3-vinyl-imidazol-1-ium, 1-hexadecyl-3-vinyl-imidazol-1-ium, 1-octadecyl-3-vinyl-imidazol-1-ium, 1-hexyl-2-methyl-3-vinyl-imidazol-1-ium, 1-octyl-2-methyl-3-vinyl-imidazol-1-ium, 1-decyl-2-methyl-3-vinyl-imidazol-1-ium, 1-dodecyl-2-methyl-3-vinyl-imidazol-1-ium, 1-tetradecyl-2-methyl-3-vinyl-imidazol-1-ium, 1-hexadecyl-2-methyl-3-vinyl-imidazol-1-ium, and 1-octadecyl-2-methyl-3-vinyl-imidazol-1-ium.

Preferred imidazolium ions are 1-butyl-3-vinyl-imidazol-1-ium, 1-hexyl-3-vinyl-imidazol-1-ium, 1-octyl-3-vinyl-imidazol-1-ium, 1-decyl-3-vinyl-imidazol-1-ium, 1-dodecyl-3-vinyl-imidazol-1-ium, 1-tetradecyl-3-vinyl-imidazol-1-ium, 1-hexadecyl-3-vinyl-imidazol-1-ium, and 1-octadecyl-3-vinyl-imidazol-1-ium.

The anion An⁻ is any desired anion, preferably a halide or carboxylate anion, preferably a halide anion.

Anions other than carboxylate anion are described, for example, in WO 2007/090755, particularly from page 20 line 36 to page 24 line 37 therein, which is hereby made part of the present disclosure content by reference.

Suitable anions are more particularly those from

the group of the halides and halogen-containing compounds of the following formulae:
F⁻, Cl⁻, Br⁻, I⁻, BF₄, PF₆⁻, AlCl₄, Al₂Cl₇⁻, Al₃Cl₁₀⁻, AlBr₄⁻, FeCl₄⁻, BCl₄⁻, SbF₆⁻, AsF₆⁻, ZnCl₃⁻, SnCl₃⁻, CuCl₂⁻, CF₃SO₃⁻, (CF₃SO₃)₂N⁻, CF₃CO₂⁻, CCl₃CO₂⁻, CN⁻, SCN⁻, OCN⁻, NO²⁻, NO³⁻, N(CN)⁻, N₃⁻;

the group of the sulfates, sulfites, and sulfonates, of the following general formulae:

SO₄²⁻, HSO₄⁻, SO₃²⁻, HSO₃⁻, R^{e}OSO₃⁻, R^{e}SO₃⁻;
the group of the phosphates, of the following general formulae:
PO₄³⁻, HPO₄²⁻, H₂PO₄⁻, R^{e}PO₄²⁻, HR^{e}PO₄⁻, R^{e}R^{f}PO₄⁻;
the group of the phosphonates and phosphinates, of the following general formula:

### R^{e}HPO₃⁻, R^{e}R^{f}PO₂⁻, R^{e}R^{f}PO₃⁻;

the group of the phosphites, of the following general formulae:
PO₃³⁻, HPO₃²⁻, H₂PO₃⁻, R^{e}PO₃²⁻, ReHPO₃⁻, R^{e}R^{f}PO₃⁻;
the group of the phosphonites and phosphinites, of the following general formula:

### R^{e}R^{f}PO₂⁻, ReHPO₂⁻, R^{e}R^{f}PO⁻, R^{e}HPO⁻;

the group of the borates, of the following general formulae:
BO₃³⁻, HBO₃²⁻, H₂BO₃⁻, R^{e}R^{f}BO₃⁻, R^{e}HBO₃⁻, ReBO₃²⁻, B(OR^{e})(OR^{f})(OR^{g})(OR^{h})⁻, B(HSO₄)⁻, B(R^{e}SO₄)⁻;
the group of the boronates, of the following general formulae:

### R^{e}BO₂²⁻, R^{e}R^{f}BO⁻;

the group of the carbonates and carbonic esters, of the following general formulae:

### HCO₃, CO₃²⁻, R^{e}CO₃⁻;

the group of the silicates and silicic acid esters, of the following general formulae:
SiO₄⁴⁻, HSiO₄³⁻, H₂SiO₄²⁻, H₃SiO₄⁻, R^{e}SiO₄³⁻, R^{e}R^{f}SiO₄²⁻, R^{e}R^{f}R^{g}SiO₄⁻, HR^{e}SiO₄²⁻, H₂R^{e}SiO₄⁻, HR^{e}R^{f}SiO₄⁻;
the group of the alkyl silane and aryl silane salts, of the following general formulae:
R^{e}SiO₃³⁻, R^{e}R^{f}SiO₂²⁻, R^{e}R^{f}R^{g}SiO⁻, R^{e}R^{f}R^{g}SiO₃⁻, R^{e}R^{f}R^{g}SiO₂⁻, R^{e}R^{f}SiO₃²⁻;
the group of the carboximides, bis(sulfonyl)imides, and sulfonylimides, of the following general formulae:

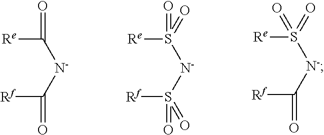

the group of the methides, of the following general formula:

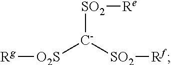

the group of the alkoxides and aryl oxides, of the following general formulae:

### R^{e}O⁻;

the group of the halometallates, of the following general formula:
[MᵣHalₜ]^{s-},
where M is a metal and Hal is fluorine, chlorine, bromine or iodine, r and t are positive integers, and indicate the stoichiometry of the complex, and s is a positive integer and indicates the charge of the complex;
the group of the sulfides, hydrogen sulfides, polysulfides, hydrogenpolysulfides, and thiolates, of the following general formulae:

### S²⁻, HS⁻, [Sᵥ]²⁻, [HSᵥ]⁻, [R^{e}S]⁻,

where visa positive integer from 2 to 10; and
the group of the complex metal ions such as Fe(CN)₆³⁻, Fe(CN)₆⁴⁻, MnO₄⁻, Fe(CO)₄⁻.

In the above anions, R^{e}, R^{f}, R^{g}, and R^{h} independently of one another are in each case hydrogen;

C₁-C₃₀ alkyl and its aryl-, heteroaryl-, cycloalkyl-, halogen-, hydroxyl-, amino-, carboxyl-, formyl-, —O—, —CO—, —CO—O— or —CO—N< substituted components, such as, for example, methyl, ethyl, 1-propyl, 2-propyl, 1-butyl, 2-butyl, 2-methyl-1-propyl (isobutyl), 2-methyl-2-propyl (tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, triacontyl, phenylmethyl (benzyl), diphenylmethyl, triphenylmethyl, 2-phenylethyl, 3-phenylpropyl, cyclopentylmethyl, 2-cyclopentylethyl, 3-cyclopentylpropyl, cyclohexylmethyl, 2-cyclohexylethyl, 3-cyclohexylpropyl, methoxy, ethoxy, formyl, acetyl or C_{q}F_{2(q-a)+(1-b)}H_{2a+b} with q≦30, 0≦a≦q and b=0 or 1 (for example, CF₃, C₂F₅, CH₂CH₂—C_{(q-2)}F_{2(q-2)+1}, C₆F₁₃, C₈F₁₇, C₁₀F₂₁, C₁₂F₂₅);
C₃-C₁₂ cycloalkyl and its aryl-, heteroaryl-, cycloalkyl-, halogen-, hydroxyl-, amino-, carboxyl-, formyl-, —O—, —CO— or —CO—O-substituted components, such as, for example, cyclopentyl, 2-methyl-1-cyclopentyl, 3-methyl-1-cyclopentyl, cyclohexyl, 2-methyl-1-cyclohexyl, 3-methyl-1-cyclohexyl, 4-methyl-1-cyclohexyl or C_{q}F_{2(q-a)-(1-b)}H_{2a-b} with q≦30, 0≦a≦q and b=0 or 1;
C₂-C₃₀ alkenyl and its aryl-, heteroaryl-, cycloalkyl-, halogen-, hydroxyl-, amino-, carboxyl-, formyl-, —O—, —CO— or —CO—O-substituted components, such as, for example, 2-propenyl, 3-butenyl, cis-2-butenyl, trans-2-butenyl or C_{q}F_{2(q-a)-(1-b)}H_{2a-b} with q≦30, 0≦a≦q and b=0 or 1;
C₃-C₁₂ cycloalkenyl and its aryl-, heteroaryl-, cycloalkyl-, halogen-, hydroxyl-, amino-, carboxyl-, formyl-, —O—, —CO— or —CO—O-substituted components, such as, for example 3-cyclopentenyl, 2-cyclohexenyl, 3-cyclohexenyl, 2,5-cyclohexadienyl or C_{q}F_{2(q-a)-3(1-b)}H_{2a-3b} with q≦30, 0≦a≦q and b=0 or 1;
aryl or heteroaryl having 2 to 30 carbon atoms, and their alkyl-, aryl-, heteroaryl-, cycloalkyl-, halogen-, hydroxy-, amino-, carboxy-, formyl-, —O—, —CO— or —CO—O-substituted components, such as, for example, phenyl, 2-methylphenyl(2-tolyl), 3-methylphenyl(3-tolyl), 4-methylphenyl, 2-ethylphenyl, 3-ethylphenyl, 4-ethylphenyl, 2,3-dimethylphenyl, 2,4-dimethylphenyl, 2,5-dimethylphenyl, 2,6-dimethylphenyl, 3,4-dimethylphenyl, 3,5-dimethylphenyl, 4-phenylphenyl, 1-naphthyl, 2-naphthyl, 1-pyrrolyl, 2-pyrrolyl, 3-pyrrolyl, 2-pyridinyl, 3-pyridinyl, 4-pyridinyl or C₆F₍₅₋ₐ₎Hₐ with 0≦a≦5; or
two radicals denote an unsaturated, saturated or aromatic ring which is unsubstituted or substituted by functional groups, aryl, alkyl, aryloxy, alkyloxy, halogen, heteroatoms and/or heterocycles, and which is uninterrupted or interrupted by one or more oxygen and/or sulfur atoms and/or by one or more substituted or unsubstituted imino groups.

In the above anions, R^{e}, R^{f}, R^{g}, and R^{h} are preferably each independently of one another a hydrogen atom or a C₁ to C₁₂ alkyl group or a CF₃.

Examples of anions include chloride; bromide; iodide; thiocyanate; isothiocyanate; azide, hexafluorophosphate; trifluoromethanesulfonate; methanesulfonate; the carboxylates, especially formate; acetate; mandelate; carbonates, preferably methyl carbonate and n-butyl carbonate, nitrate; nitrite; trifluoroacetate; sulfate; hydrogensulfate; methylsulfate; ethylsulfate; 1-propylsulfate; 1-butylsulfate; 1-hexylsulfate; 1-octylsulfate; phosphate; dihydrogenphosphate; hydrogen-phosphate; C₁-C₄ dialkylphosphates; propionate; tetrachloroaluminate; Al₂Cl₇—; chlorozincate; chloroferrate; bis(trifluoromethylsulfonyl)imide; bis(pentafluoroethylsulfonyl)imide; bis(methylsulfonyl)imide; bis(p-tolylsulfonyl)imide; tris(trifluoromethylsulfonyl)methide; bis(pentafluoroethylsulfonyl)methide; p-tolylsulfonate; tetracarbonylcobaltate; dimethylene glycol monomethyl ether sulfate; oleate; stearate; acrylate; methacrylate; maleate; hydrogencitrate; vinylphosphonate; bis(pentafluoroethyl)phosphinate; borates such as bis[salicylato(2-)]borate, bis[oxalato(2-)]borate, bis[1,2-benzenediolato(2-)-O,O′]borate, tetracyanoborate, tetrafluoroborate; dicyanamide; tris(pentafluoroethyl)trifluorophosphate; tris(heptafluoropropyl)trifluorophosphate, cyclic arylphosphates such as pyrrocatechol-phosphate (C₆H₄O₂)P(O)O—, and chlorocobaltate.

Particularly preferred anions are those from the group of the halides, especially chloride, bromide, iodide, azide, thiocyanate, acetate, methyl carbonate, tetrafluoroborate, trifluoromethanesulfonate, methanesulfonate, bis(trifluoromethylsulfonyl)imide, ethylsulfate and diethyl phosphate.

Examples of suitable vinyl-imidazolium compounds j) include:

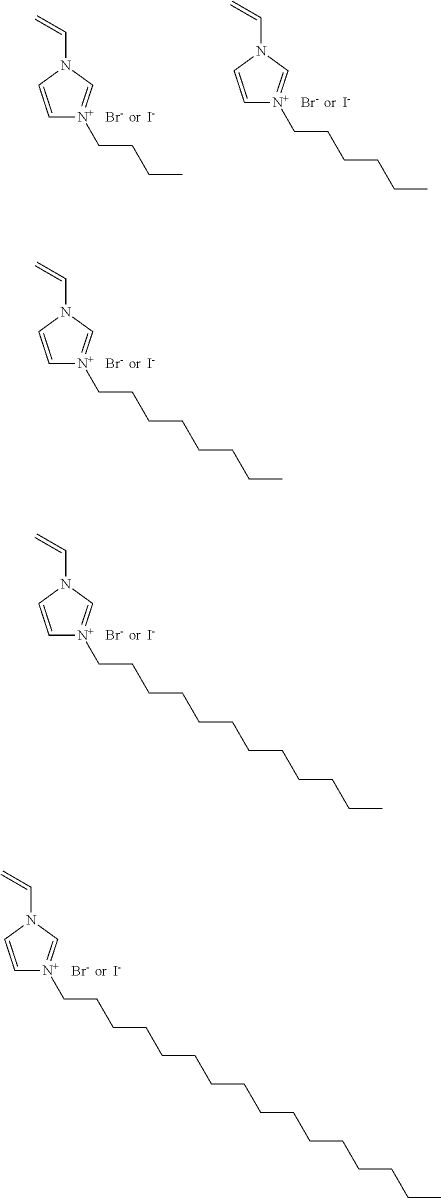

Suitable flux enhancing monomers bearing quarternary ammonium or phosphonium groups k) are for example selected from compounds of the general formula

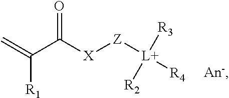

wherein
R₁═H, methyl, preferably methyl,
X═O, NH preferably 0,
Z=alkylene or polyoxyalkylene, preferably ethylene or polyoxyalkylene (polyalkylenglycol, preferably poly(ethylene glycol), poly(propylene glycol); poly(2-alkyl-2-oxazoline), preferably poly(2-methyl-2-oxazoline), poly(2-ethyl-2-oxazoline));
L=N, P; preferably N
R², R³, R⁴=alkyl; preferably R²═R³=methyl; R⁴=preferably C₆-C₂₂, more preferably C₈-C₁₈, especially preferably C₈-C₁₂, particularly preferably C₁₂,
An⁻: counterion, preferably bromide or iodide.

Examples of biocidal monomers bearing quarternary ammonium groups are for example

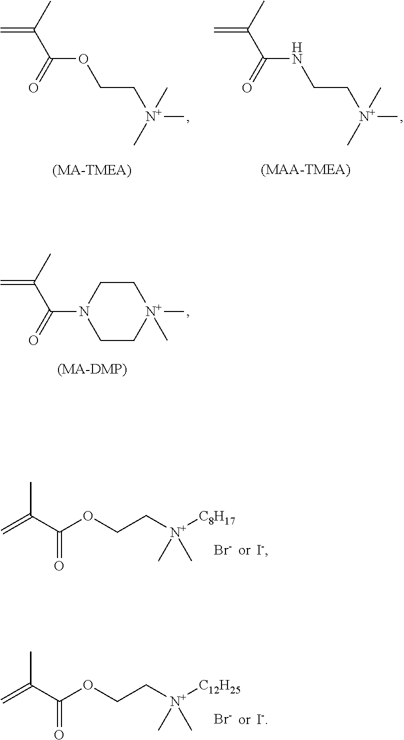

Further suitable flux enhancing monomers bearing quarternary ammonium groups are 3-methacryloyl aminopropyl-trimethyl ammoniumchloride, 2-methacryloyl oxyethyltrimethyl ammonium chloride, 2-Methacryloyloxyethyl-trimethylammoniummethosulfate, 3-acrylamidopropyl trimethylammoniumchloride, trimethylvinylbenzyl-ammoniumchlorid, 2-acryloyloxyethyl-4-benzoylbenzyl-dimethyl ammoniumbromide, 2-acryloyloxyethyltrimethylammoniummethosulfate, N,N,N-Trimethylammonium-ethylenebromide, 2-hydroxy N,N,N-trimethyl-3-[(2-methyl-1-oxo-2-propenyl)oxy]-ammoniumpropane chloride, N,N,N-Trimethyl-2-[(1-oxo-2-propenyl)oxy]-ammoniumethane-methylsulfate, N,N-Diethyl-N-methyl-2-[(1-oxo-2-propenyl)oxy]-ammoniumethane-methylsulfate, N,N,N-trimethyl-2-[(1-oxo-2-propenyl)oxy]-ammonium ethanechloride, N,N,N-trimethyl-2-[(2-methyl-1-oxo-2-propenyl)oxy]-ammonium ethanechloride, N,N,N-trimethyl-2-[(2-methyl-1-oxo-2-propenyl)oxy]-ammoniumethan-methylsulfate, N,N,N-triethyl-2-[(1-oxo-2-propenyl)amino]-ammoniumethan.

Further suitable biocidal monomers bearing quarternary ammonium or phosphonium groups are for example selected from compounds of the general formula

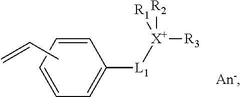

wherein
X═N, P; preferably N,
L₁=alkylene or polyoxyalkylene, preferably ethylene or polyoxyalkylene (polyalkylenglycol, preferably poly(ethylene glycol), poly(propylene glycol); poly(2-alkyl-2-oxazoline), preferably poly(2-methyl-2-oxazoline), poly(2-ethyl-2-oxazoline)),
R₁, R₂, R₃=independently alkyl, aryl or aralkyl;
   If X═N: preferably R₁═R₂=methyl; R₃=preferably C₆-C₂₂, more preferably C₈-C₁₈, especially preferably C₈-C₁₂, particularly preferably C₁₂;
   If X═P: preferably R₁═R₂═R₃=octyl, butyl or phenyl;
An⁻: counterion, preferably halide, most preferably chloride, bromide or iodide.

Examples of further suitable biocidal monomers bearing quarternary ammonium or phosphonium groups include:

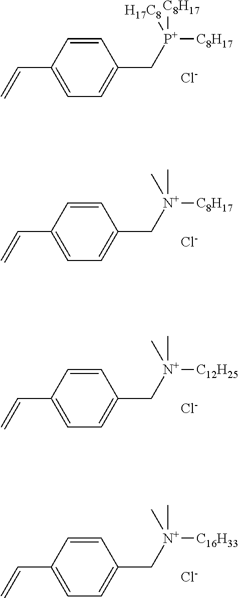

Suitable diallyldialkylammoniumchlorides I) are for example diallyldimethylammoniumchloride (DADMAC).

Suitable alkylaminoalkyl (meth)acrylate and alkylaminoalkyl (meth)acrylamide m) are for example those according to formula (I)

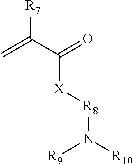

wherein
R₇ is H or CH₃,
R₈ is C₁-C₅ alkyl bi-radical,
R₉ and R₁₀ are independently H or C₁-C₅alkyl radical which can be linear or branched, and X is a divalent radical of —O—, —NH— or —NR₁₁, wherein R₁₁ is C₁-C₆alkyl.

Preferred flux enhancing monomers according to formula (I) are 2-tert-butylaminoethyl (meth)acrylate (tBAEMA), 2-d imethylaminoethyl (meth)acrylate, 2-diethylaminoethyl (meth)acrylate, 3-dimethylaminopropyl (meth)acrylate, N-3-dimethylaminopropyl (meth)acrylamide, and N-3-diethylaminopropyl (meth)acrylamide with the most preferred being 2-tert-butylaminoethyl (meth)acrylate (tBAEMA).

The coating may be formed from a flux enhancing monomer meeting the description of formula (I) only or may be formed from additional monomers. For example, the coating may be formed from one or more flux enhancing monomers of formula (I) selected from the group consisting of -tert-butylaminoethyl (meth)acrylate (tBAEMA), 2-dimethylaminoethyl (meth)acrylate, 2-diethylaminoethyl (meth)acrylate, 3-dimethylaminopropyl (meth)acrylate, N-3-dimethylaminopropyl (meth)acrylamide, and N-3-diethylaminopropyl (meth)acrylamide. Alternatively, the oligomer may be formed from the monomers of formula (I) and additional monomers not meeting the definition of formula (I).

However, in one preferred embodiment the coating is formed only from monomers meeting the definition of formula (I). While the coating may be a copolymer it is preferable that the coating is a homopolymer.

Another preferred coating of the present invention is obtained from t-butylaminoethyl methacrylate (tBAEMA) and is represented by formula (II).

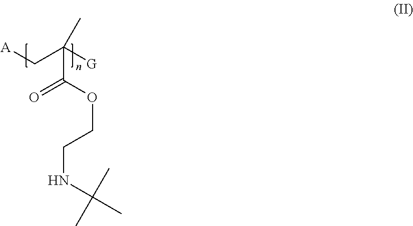

where n is from 2 to 100, and A and G are residual groups derived from the borane, which acts as an activator, optionally further initiators and optionally a chain transfer agent used in polymerization. Preferably n is from 5 to 60, and most preferably from 10 to 40.

n represents the degree of polymerization.

A and G are derived from the borane, which acts as an activator, optionally further activators and optionally chain transfer agents. The further polymerization activators may be selected from the group consisting of free radical polymerization activators, atom transfer radical polymerization (ATRP) activators, nitroxide-mediated radical polymerization (NMP) activators, reversible addition-fragmentation chain transfer polymerization (RAFT) or macromolecular design via interchange of xanthates (MADIX), preferably atom transfer radical polymerization (ATRP).

It is also possible that the further activators are atom transfer radical polymerization activators (ATRP) and in this case A and G may be derived from alkyl halide activators. Thus, A may be an alkyl 2-isobutyrate radical and G a halide which can be obtained by using an alkyl 2-haloisobutyrate ATRP activators. Most especially in the case of ATRP, G is a bromide or an iodide, which may presumably contribute to enhance antifungal activity of the antimicrobial oligomers of the present invention.

The molecular weights of coatings formed from formula (I) and/or represented by formula (II) are measured by gel permeation chromatography (GPC) using poly(methyl methacrylate) narrow molecular weight standards. The coatings may be of a weight average molecular weight (Mw) ranging from 400 to 20,000 g/mole, preferably from 1000 to 10,000.

Most preferably the weight average molecular weight (Mw) of the coatings ranges from 400 to 20,000 g/mole and a number average molecular weight (Mn) from 400 to 10,000 g/mole.

In particular, oligomers of pTBAEMA having a Mw=<20K are characterized by a Tg of =<30° C. preferably =<25° C. Accordingly, the Tg of the polymer formed from a monomer of formula (I) or an oligomer of formula (II) has a Tg of =<30° C., preferably =<25° C. or less.

The coatings formed from formula (I) and oligomers of formula (II) preferably have a narrow molecular weight distribution with a polydispersity index ranging from (PDI=Mw/Mn) of 1.0 to 4.0, preferably 1.0 to 3.0.

Most preferably, the oligomers formed from formula (I) and oligomers of formula (II) have Mw ranging from 1000 to 10,000 with a PDI ranging from 1.0 to 2.0.

The coatings can be crosslinked or non-crosslinked but preferably the coatings are non-crosslinked.

Suitable Polylysine (meth)acrylamides or (meth)acrylates n) are for example epsilon-poly-Llysine methacrylamide:

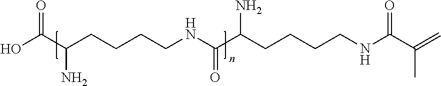

Suitable N-alkyl-4-vinylpridinium and alkyl-2-vinyl-pyridinium salts o) are for example the bromides and iodides of methyl in particular bromides and iodides N-methyl-4-vinylpridinium and N-methyl-2-vinyl-pyridi nium.

Suitable biocidal monomers bearing guanide and biguanide groups p) are for example (Meth)acryloyl-modified Poly(hexamethylene biguanide)

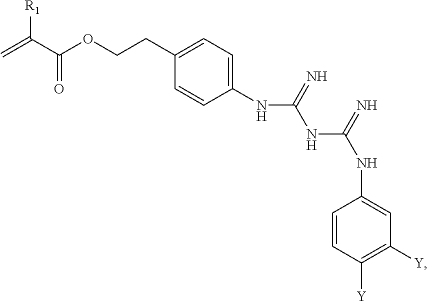

wherein R₁═H, methyl; Y═H, methyl.

Examples of suitable biocidal monomers bearing guanide and biguanide groups p) include:

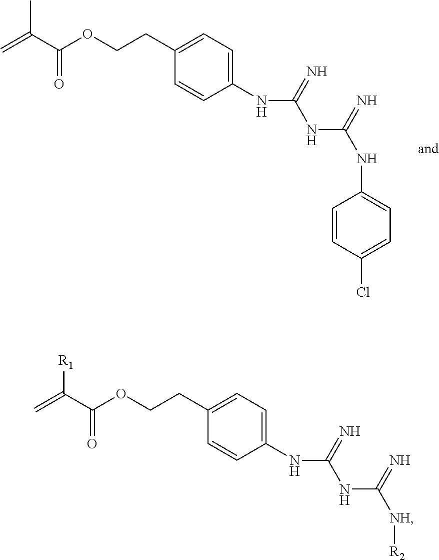

wherein
R₁═H, methyl
R₂=alkyl, aryl, aralkyl, preferentially R₂=2-ethyl-hexyl, hexyl, octyl, decyl, dodecyl, tetradecyl, hexadecyl, octadecyl

Suitable halamines q) are for example chloramine

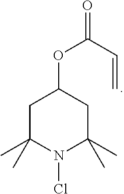 [SMILES: C=CC(=O)OC1CC(C)(C)N(Cl)C(C)(C)C1]

Flux enhancing monomers can be used alone, so that the coating is for example a homopolymer or homo oligomer.

Flux enhancing monomers can also be used in combination with other flux enhancing monomers.

In one embodiment of the invention, membranes comprise a coating comprising only antiadhesive monomers as flux enhancing monomers.

In one embodiment of the invention, membranes comprise a coating comprising only biocidal monomers as flux enhancing monomers.

In one embodiment of the invention, membranes comprise a coating comprising only one antiadhesive monomer and no biocidal monomer as flux enhancing monomer.

In one embodiment of the invention, membranes comprise a coating comprising only one biocidal monomer and no antiadhesive monomer as flux enhancing monomer.

In one embodiment of the invention, membranes comprise a coating comprising at least one antiadhesive and least one biocidal monomer as flux enhancing monomers.

Flux enhancing monomers can also be used in combination with further monomers having no flux enhancing effect.

Suitable further monomers are monomers comprising an ethylenically unsaturated double bond that by themselves do not qualify as flux enhancing monomers a) to q) as defined above. Examples of further monomers include acrylic acid, methacrylic acid, alkyl (meth)acrylate and alkyl (meth)acrylamide, in particular methyl (meth)acrylate, ethyl (meth)acrylate, butyl (meth)acrylate, lauryl (meth)acrylate, ethylhexyl (meth)acrylate, 4-hydroxy butyl (meth)acrylate, phenoxyethyl (meth)acrylate, styrene, alkyl vinyl ether, in particular, methyl vinyl ether, ethyl vinyl ether, n-butyl vinyl ether, 4-hydroxybutyl vinyl ether, vinyl acetate, acrylic nitrile, maleic anhydride.

When reference is made in this application to embodiments of membranes comprising certain flux enhancing monomers or combinations of flux enhancing monomers, this shall be understood to include membranes or filtration systems that have been obtained using a composition comprising the respective flux enhancing monomers or combinations of flux enhancing monomers.

In one embodiment of the invention, membranes according to the invention comprise at least one antiadhesive and/or biocidal monomer, with the proviso that said at least one antiadhesive and/or biocidal monomer is different from antiadhesive monomers a) as defined above.

In one embodiment of the invention, membranes according to the invention comprise at least one antiadhesive and/or biocidal monomer, with the proviso that said at least one antiadhesive and/or biocidal monomer is not an acrylic ester.

In one embodiment of the invention, membranes according to the invention comprise at least one antiadhesive monomer a) as defined above.

In one embodiment of the invention, membranes according to the invention comprise at least one antiadhesive monomer b)-i) as defined above.

In one embodiment of the invention, membranes according to the invention comprise at least one antiadhesive monomer a) as defined above in combination with at least one antiadhesive and/or biocidal monomer selected from monomers b) to q) as defined above.

In one embodiment of the invention, membranes according to the invention comprise at least one antiadhesive monomer b)-i) as defined above in combination with at least one antiadhesive and/or biocidal monomer selected from monomers c) to q) as defined above.

In one embodiment of the invention, membranes according to the invention comprise at least one antiadhesive monomer a) as defined above in combination with at least one antiadhesive and/or biocidal monomer selected from monomers b) to q) as defined above.

In one embodiment of the invention, membranes according to the invention comprise at least one antiadhesive monomer b) to i) as defined above.

Typically, coatings according to the invention comprise 2 to 100% by weight, preferably 5 to 90% by weight of flux enhancing monomers and 98 to 0% by weight or 95 to 10% by weight of further monomers. (relative to the overall mass of the polymer). In one embodiment coatings comprise 50 to 90% by weight, preferably 75% to 90% or 80% to 90% by weight of flux enhancing monomers. In another embodiment coatings comprise 10 to 50% by weight, preferably 20 to 30% by weight of flux enhancing monomers (relative to the overall mass of the polymer).

In one embodiment, membranes according to the invention comprise tBAEMA in combination with at least one flux enhancing monomer comprising at least one quaternary ammonium group.

In another embodiment, membranes according to the invention comprise tBAEMA in combination with at least one halamine.

In another embodiment, membranes according to the invention comprise at least one flux enhancing monomer comprising at least one quaternary ammonium group in combination with at least one halamine.

In one embodiment, membranes according to the invention comprise tBAEMA in combination with at least one flux enhancing monomer comprising at least one quaternary ammonium group and with at least one halamine.

In one embodiment, membranes according to the invention comprise HEMA (2-Hydroxyethyl methacrylate) and QAEMA ([2-(methacryloyloxy)ethyl]trimethylammonium chloride).

In another embodiment membranes according to the invention comprise HEMA (2-Hydroxyethyl methacrylate), QAEMA ([2-(methacryloyloxy)ethyl]trimethylammonium chloride) and acrylic acid.

In a preferred embodiment, membranes according to the invention comprise vinyl pyrrolidone in combination with at least one biocidal monomer j), k), l), m), n), o), p) or q).

The at least one flux enhancing monomer can be applied on the base membrane neat or in solution with a solvent. Depending on the nature of the flux enhancing monomers and the further monomers used, different solvents can be used. Examples of suitable solvents are water, THF, dioxane, alcohols or mixtures thereof. Preferred solvents are water or alcohols, in particular water or isopropanol or mixtures thereof. In a preferred embodiment of the present invention, flux enhancing monomers and the further monomers are applied in solution at a concentration in the range of from 0.01 to 70% by weight, more preferably in the range of from 0.5 to 60% by weight, based on the overall content of flux enhancing and further monomers.

In one embodiment, the composition comprising the at least one flux enhancing monomer optionally comprises further additives like dispersants. Further additives that can be comprised are known in the art.

The coating normally has a thickness of 1 nm to 100 μm, preferably 2 nm to 1 μm, more preferably 5 nm to 0.1 μm.

The coating can be crosslinked or non-crosslinked or non-crosslinked.

According to the invention a deblocking agent can optionally be employed. A deblocking agent is a compound that is able to split an organoborane-amine complex to liberate the organoborane. Suitable deblocking agents are for example Lewis acids like aluminium trichloride and trifluoroborane, Broensted acids like mineral acids or organic acids, e.g. acrylic acid, methacrylic acid, acetic acid or citric acid, carbon dioxide, aldehydes, ketones, etc. Preferred deblocking agents are acrylic acid and methacrylic acid.

In another embodiment of the present invention an organoborane-amine complex is employed that will sufficiently dissociate at higher temperatures to initiate radical polymerization so that the liberation of the organoborane can be achieved by simple heating of the reaction mixture. In such cases a further deblocking agent is obsolete.

Treatment with at least one radically polymerizable monomer compound and optionally at least one deblocking agent is usually carried out at a temperature of from 0 to 80° C., preferably at room temperature, during a time of from 1 to 100 minutes, preferably of from 10 to 60 minutes.

After the treatments according to the invention any excess polymerized material that is not grafted onto the surface of the piece of polymer can be removed, e.g. by scrubbing the surface with a clean brush under running water or by dissolving any excess polymerized material in a suitable solvent.

Membranes according to the invention are normally obtained by consecutive
A) treatment of a base membrane with at least one organoborane-amine complex,
B) treatment with a composition comprising at least one radically polymerizable compound
C) optional treatment with a deblocking agent.

In a preferred embodiment of the present invention, the treatment of the base membrane with an organoborane-amine complex is accomplished by submersing the base membrane in a solution of the organoborane-amine complex. The treatment occurs usually at a temperature of from 0 to 60° C., preferably at room temperature, for a time of from 0.1 to 60 minutes, preferably of from 1 to 10 minutes.

At the end of the treatment the base membrane is typically removed from the solution of the organoborane-amine complex and afterwards treated with at least one flux enhancing monomer and optionally a deblocking agent. Again, this treatment is preferably accomplished by submersing the base membrane in a solution comprising at least one flux enhancing monomer and optionally at least one deblocking agent. Alternatively, the based membrane is submersed in a solution comprising only the at least one flux enhancing monomer and the at least one deblocking agent is optionally added neat or in solution. No deblocking agent is needed when the monomer itself acts as a deblocking agent (e.g. in the case of acrylic acid) or deblocking can be achieved thermally.

Another aspect of the invention is a process for making membranes comprising the steps
A) treatment of a base membrane with at least one organoborane-amine complex,
B) treatment with a composition comprising at least one radically polymerizable compound
C) optional treatment with a deblocking agent.

Another aspect of the invention is a method of improving the flux of membranes, which comprises the following steps:
A) treatment of a base membrane with at least one organoborane-amine complex
B) treatment a composition comprising at least one radically polymerizable compound
C) optional treatment with a deblocking agent.

Another aspect of the invention is a composition comprising at least one flux enhancing monomer selected from
a) esters of (meth)acrylic acid polyols
b) vinyl ethers of polyols
c) hydrophilic macromonomers different from monomers a) and b)
d) N-vinyl compounds
e) Low molecular weight hydrophilic (meth)acrylamides
f) (meth)acrylates or (meth)acrylamides bearing epoxy groups
g) monomers having a betain structure
h) hydrophilic monomers selected from hydroxyethyl-(meth)acrylate, vinyl alcohol, (Meth)acryloyl and (meth)acrylamide-modified mono- and oligosaccharides,

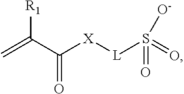

with R₁═H, Methyl; X═O, NH;
i) Ion pair comonomers
j) vinyl-imidazolium compounds
k) ethylenically unsaturated monomers bearing quarternary ammonium or phosphonium groups
l) diallyldialkylammoniumchlorides
m) alkylaminoalkyl (meth)acrylates and alkylaminoalkyl (meth)acrylamides
n) Polylysine (meth)acrylamides or (meth)acrylates
o) alkyl-4-vinylpridinium and alkyl-2-vinyl-pyridinium salts, in particular bromides and iodides
p) ethylenically unsaturated monomers bearing guanide and biguanide groups
q) halamines.

For compositions according to the invention the same embodiments and preferred embodiments with respect to the choice of flux enhancing monomers apply as for membranes according to the invention.

In one embodiment of the invention, compositions according to the invention comprise at least one antiadhesive and/or biocidal monomer, with the proviso that said at least one antiadhesive and/or biocidal monomer is different from antiadhesive monomers a) as defined above.

In one embodiment of the invention, compositions according to the invention comprise at least one antiadhesive and/or biocidal monomer, with the proviso that said at least one antiadhesive and/or biocidal monomer is not an acrylic ester.

In one embodiment of the invention, compositions according to the invention comprise at least one antiadhesive monomer a) as defined above.

In one embodiment of the invention, compositions according to the invention comprise at least one antiadhesive monomer b)-i) as defined above.

In one embodiment of the invention, compositions according to the invention comprise at least one antiadhesive monomer from b)-g) as defined above.

In one embodiment of the invention, compositions according to the invention comprise at least one antiadhesive monomer a) as defined above in combination with at least one antiadhesive and/or biocidal monomer selected from monomers b) to q) as defined above.

In one embodiment of the invention, compositions according to the invention comprise at least one antiadhesive monomer a) as defined above in combination with at least one antiadhesive and/or biocidal monomer selected from monomers b) to g) and/or i) to q) as defined above.

In one embodiment of the invention, compositions according to the invention comprise at least one antiadhesive monomer b)-i) as defined above in combination with at least one antiadhesive and/or biocidal monomer selected from monomers c) to q) as defined above.

In one embodiment of the invention, compositions according to the invention comprise at least one antiadhesive monomer a) as defined above in combination with at least one antiadhesive and/or biocidal monomer selected from monomers b) to q) as defined above.

In one embodiment of the invention, compositions according to the invention comprise at least one antiadhesive monomer b) to i) as defined above.

In one embodiment, compositions according to the invention comprise 5 to 95% by weight of flux enhancing monomers and 95 to 5% by weight of further monomers relative to the overall mass of the coating.

In one embodiment of the invention, compositions according to the invention comprise tBAEMA in combination with at least one flux enhancing monomer comprising at least one quaternary ammonium group.

In one embodiment of the invention, compositions according to the invention comprise tBAEMA in combination with at least one halamine.

In another embodiment, compositions according to the invention comprise at least one flux enhancing monomer comprising at least one quaternary ammonium group in combination with at least one halamine.

In one embodiment, compositions according to the invention comprise tBAEMA in combination with at least one flux enhancing monomer comprising at least one quaternary ammonium group and with at least one halamine.

In one embodiment, compositions according to the invention comprise HEMA (2-Hydroxyethyl methacrylate) and QAEMA ([2-(methacryloyloxy)ethyl]trimethylammonium chloride).

In another embodiment compositions according to the invention comprise HEMA (2-Hydroxyethyl methacrylate), QAEMA ([2-(methacryloyloxy)ethyl]trimethylammonium chloride) and acrylic acid.

In a preferred embodiment, compositions according to the invention comprise vinyl pyrrolidone in combination with at least one biocidal monomer j), k), l), m), n), o), p) or q).

Another aspect of the invention is the use of a composition according to the invention for improving the flux of membranes, or for imparting biocidal and/or antiadhesive properties to a membrane.

Another aspect of the invention is the use of a composition comprising at least one flux enhancing monomer for improving the flux of membranes, or for imparting biocidal and/or antiadhesive properties to a membrane.

Filtration systems and membranes according to the invention show improved properties with respect to the decrease of flux over time and their fouling and particularly biofouling properties. Filtration systems and membranes according to the invention are easy and economical to make. In particular they can be made without the need for irradiation with UV light or other radiation, thus allowing the coating of also three dimensional surfaces. Furthermore, no complex equipment is required for making filtration systems or membranes according to the invention.

Filtration systems and membranes according to invention can be made using aqueous or alcoholic systems and are thus environmentally friendly. Furthermore, leaching of toxic substances is not problematic with membranes according to the invention.

Membranes according to the invention have a long lifetime and allow for the treatment of water.

Membranes according to the invention can be cleaned more easily and with lower amounts of cleaning agents.

Membranes according to the invention have longer cleaning cycles meaning that they need to be cleaned less often than membranes known from the art.

In a preferred embodiment, membranes according to the invention are used for the treatment of sea water or brackish water.

In one preferred embodiment of the invention, membranes according to the invention, particularly RO, FO or NF membranes are used for the desalination of sea water or brackish water.

Membranes according to the invention, particularly RO, FO or NF membranes are used for the desalination of water with a particularly high salt content of for example 3 to 8% by weight. For example membranes according to the invention are suitable for the desalination of water from mining and oil/gas production and fracking processes, to obtain a higher yield in these applications.

Different types of membrane according to the invention can also be used together in hybrid systems combining for example RO and FO membranes, RO and UF membranes, RO and NF membranes, RO and NF and UF membranes, NF and UF membranes.

In another preferred embodiment, membranes according to the invention, particularly NF, UF or MF membranes are used in a water treatment step prior to the desalination of sea water or brackish water.

In another preferred embodiment membranes according to the invention, particularly NF, UF or MF membranes are used for the treatment of industrial or municipal waste water.

Membranes according to the invention, particularly RO and/or FO membranes can be used in food processing, for example for concentrating, desalting or dewatering food liquids (such as fruit juices), for the production of whey protein powders and for the concentration of milk, the UF permeate from making of whey powder, which contains lactose, can be concentrated by RO, wine processing, providing water for car washing, making maple syrup, during electrochemical production of hydrogen to prevent formation of minerals on electrode surface, for supplying water to reef aquaria

Membranes according to the invention, particularly UF membranes can be used in medical applications, dialysis and other blood treatments, concentration for making cheese, processing of proteins, desalting and solvent-exchange of proteins, fractionation of proteins, clarification of fruit juice, recovery of vaccines and antibiotics from fermentation broth, laboratory grade water purification, drinking water disinfection (including removal of viruses), removal of endocrines and pesticides combined with suspended activated carbon pretreatment.

Membranes according to the invention, particularly RO, FO, NF membranes can be used for rehabilitation of mines, homogeneous catalyst recovery, desalting reaction processes.

Membranes according to the invention, particularly NF membranes, can be used for separating divalent ions or heavy and/or radioactive metal ions, for example in mining applications, homogeneous catalyst recovery, desalting reaction processes.

### EXAMPLES

### Determination of Antiadhesive Properties (Proteins)

RO membranes were painted black at the macroporous backside. Pieces of 9 mm in diameter were punched out and put into a 48 well plate. Into each well, 500 μL of buffer solution (10 mmol/l HEPES, pH 7.4) was added and the samples equilibrated for 30 min. Then 100 μL of the buffer solution were replaced with 100 μL of a solution of 0.2 g/I fluorescently-labelled fibrinogen (from human plasma, AlexaFluor® 647 Conjugate, Molecular Probes®) in buffer (10 mmol/l HEPES, pH 7.4) and the samples equilibrated for 2 hours at 30° C. Subsequently, the samples were rinsed by 5 times replacing 400 μL of the 500 μL solution in each well with 400 μL pure buffer (10 mmol/l HEPES, pH 7.4). Samples were then transferred to a new 48 well plate and covered with 500 μL of buffer solution (10 mmol/l HEPES, pH 7.4). The well plates were analysed in a microarray fluorescence scanner.

### Determination of Antiadhesive Properties (Bacteria):

Coated membranes were tested against bacterial adhesion (Styphylococcus aureus). The membrane was cut and sealed in a holder such that only the coated upper surface was accessible to liquids. The coated surface was then covered with approximately 1 ml of a bacterial suspension (Staphylococcus aureus, OD600˜1, in 0.5% TSBY/0.9% NaCl supplemented with Syto9® and propidium iodide fluorescent dyes as specified by the supplier (Film Tracer Live/Dead® Biofilm Viability Kit, Invitrogen)). After incubation of the bacteria on the surface for one hour at 37° C., planktonic cells were rinsed off by repeated (10 times) exchange of 90% of the liquid supernatant with bacteria-free 0.9% NaCl solution. This way, the membrane surface was kept moist during all steps of the procedure. Bacteria attached to the membrane surface (sessile cells) were then detected and enumerated either by fluorescence microscopy or by punching out a small piece, followed by bacteria recovery by ultrasonication and serial dilution plating.

### Determination of Antimicrobial Activity:

Antimicrobial activity of coated membranes was determined either by testing according to ISO 22196 (JIS Z2801) or by a fluorescence microscopy assay as detailed below:

### 1. Bacterial Culture:

50 ml of DSM 92 medium (=TSBY Medium, Deutsche Sammlung von Mikroorganismen and Zellkulturen GmbH) in an Erlenmeyer flask with chicane are inoculated with a single colony of Staphylococcus aureus ATCC 6538P and incubated at 190 rpm and 37° C. for 16 hours. The resulting preliminary culture has a cell density of approximately 10⁸ CFU/ml, corresponding to an optical density of OD=7.0-8.0. Using this preliminary culture, 15 ml of main culture in 5% DSM 92 medium with an optical density of OD=1.0 are prepared.

### 2. Fluorescence Staining:

500 μl of the main bacterial culture are stained in accordance with the manufacturer recommendation using 1.5 μl of Syto 9 fluorescent dye and 1.5 μl of propidium iodide fluorescent dye (Film Tracer™ LIVE/DEAD® Biofilm Viability Kit, from Invitrogen). 10 μl of this bacterial suspension are applied to the surface under investigation, and covered with a cover slip. A homogeneous film of liquid is formed, with a thickness of about 30 μm. The test substrates are incubated in the dark at 37° C. for up to 2 hours. After this time, >95% living bacterial cells are found on untreated reference substrates (including pure glass).

### 3. Microscopy:

The test substrates are examined under a Leica DMI6000 B microscope with the cover slip facing the lens. Each test substrate is advanced automatically to 15 pre-defined positions, and images are recorded in the red (R) and green (G) fluorescence channel. The absorbance and emission wavelengths in the fluorescence channels are adapted to the dyes used. Bacteria with an intact cell membrane (living) are detected in the green channel, bacteria with a defective cell membrane (dead) are detected in the red channel. For each of the 15 positions, the number of bacteria in both channels is counted. The percentage of dead bacteria is calculated from the numbers in R/(R+G). The percentage of dead bacteria is averaged over the 15 positions and reported as the result.

### Example 1

A flat sheet reverse osmosis membrane comprising a separation layer based on polyamide with a molecular weight cutoff of 100 Da (RO membrane YMADSP3001 from GE Osmotics) was provided. Sheet of 150 cm² of this membrane was stored over 24 hours in 1 Liter of deionized water to remove glycerol from the pores. Afterwards, the water wetted membrane was immersed in 10% by weight solution of triethylborane-diaminopropane (TEB.DAP) in isopropanol for 1 minute. The membrane was immersed for 1 minute in 10% by weight aqueous solution of monomer mixtures HEMA (2-Hydroxyethyl methacrylate, 97%):QAEMA ([2-(methacryloyloxy)ethyl]trimethylammonium chloride), 80%):AAc (acrylic acid), 99%.

Monomers were mixed in the weight ratio 1:1:0.1 (HEMA:QAEMA:AAc). The membrane was then washed with deionized water.

The so prepared membranes showed increased antimicrobial and antiadhesive activity.

### Example 2

A flat sheet reverse osmosis membrane comprising a separation layer based on polyamide (RO membrane SW30XLE procured from DOW Chemicals) was provided. A Sheet of 150 cm2 of this membrane was stored in 1 Liter of deionized water for 24 hours. Afterwards, the water wetted membrane was immersed in 10% by weight solution triethylborane-diaminopropane (TEB.DAP) in isopropanol for 1 minute. The membrane was immersed for 1 minute in 5% by weight aqueous solution of monomer mixtures tBAEMA (Tert.butylaminoethyl acrylate 97%):AAc (acrylic acid), 99%. Monomers were mixed in the weight ratio 1:0.1 (tBAEMA:AAc). The membrane was then washed with deionized water.

The so prepared membranes showed increased antimicrobial and antiadhesive activity.

### Example 3

A flat sheet reverse osmosis membrane comprising a separation layer based on polyamide (RO membrane TORAY Flat Sheet Membranes, UTC-80E, PN:YM80ESP18) was provided. A Sheet of 150 cm2 of this membrane was stored in 1 Liter of deionized water for 24 hours. Afterwards, the water wetted membrane was immersed in 10% by weight solution of triethylborane-diaminopropane (TEB.DAP) in isopropanol for 1 minute. The membrane was immersed for 1 minute in 5% by weight aqueous solution of monomer mixtures tBAEMA (Tert.butylaminoethyl acrylate 97%):AAc (acrylic acid), 99%. Monomers were mixed in the weight ratio 1:0.1 (tBAEMA:AAc). The membrane was then washed with deionized water.

The so prepared membranes showed increased antimicrobial and antiadhesive activity.

### Example 4

### Preparation of a Reverse Osmosis Membrane

The support ultrafiltration membranes based on polyethersulfone were first stored overnight (>12 h) in deionized water. Afterwards the membrane surface was treated with a rubber roller to remove water droplets and the membrane was fixed in a frame structure (PMMA plate and a silicone and PMMA frame). An aqueous 1.5-2% (w/v) m-phenylenediamine solution (deionised water) and 0.025 to 1.32b % (w/v) trimesoyl chloride solution in dry dodecane were prepared. 50 ml of the m-phenylenediamine solution was poured into the frame construction onto the membrane surface. The exposure time was 10 min. After pouring off the m-phenylenediamine solution and disassembling the frame construction, the wetted membrane was placed on a PMMA (polymethylmethacrylate) plate covered with a paper towel. With a rubber roller solution droplets were gently removed from the membrane surface. The tissues were removed and the membrane was clamped in the frame construction again. Now the one-minute polycondensation reaction was initiated by adding 50 ml of 0.025 to 1.3% (w/v) trimesoyl chloride solution. The trimesoyl chloride solution was poured out of the frame construction and the frames were disassembled. In order to remove residual monomer solution from the membrane surface, the membrane was rinsed with 75 ml of n-hexane on the PMMA plate in a tilted position. The membrane was placed down to evaporated the hexane for one minute. The thin film composite membrane with the gleaming polyamide layer was finally stored in deionized water for 24 h.

### Example 5

### Coating of the Membrane from Example 4

A sheet of 150 cm2 of the membrane obtained in example 11 was stored in 1 Liter of deionized water for 24 hours. Afterwards, the water wetted membrane was immersed in 10% by weight solution of triethylborane-diaminopropane (TEB.DAP) in isopropanol for 1 minute. The membrane was immersed for 1 minute in 5% by weight aqueous solution of monomer mixtures tBAEMA (Tert.butylaminoethyl acrylate 97%):AAc (acrylic acid), 99%. Monomers were mixed in the weight ratio 1:0.1 (tBAEMA:AAc). The membrane was then washed with deionized water.

The so prepared membranes showed increased antimicrobial and antiadhesive activity.

1. A filtration system, comprising at least one membrane obtained by a process comprising:
A) treating a component of the membrane with at least one organoborane-amine complex;
B) treating the component with a composition comprising at least one radically polymerizable compound; and
C) optional treating the component with a deblocking agent, wherein said composition comprises at least one of
an antiadhesive monomer selected from the group consisting of
a) an ester of a (meth)acrylic acid polyol wherein (meth)acrylic esters with polyalkyleneoxides are excluded,
b) a vinyl ether of a polyol,
c) a hydrophilic macromonomer different from monomers a) and b),
d) an N-vinyl compound different from N-vinyl pyrrolidone,
e) a low molecular weight hydrophilic (meth)acrylamide,
f) a (meth)acrylate or (meth)acrylamide bearing at least one epoxy group,
g) a monomer having a betain structure,
h) a hydrophilic monomer selected from the group consisting of a hydroxyethyl-(meth)acrylate, vinyl alcohol, (Meth)acryloyl and (meth)acrylamide-modified mono- and oligosaccharides, 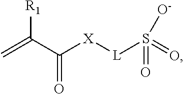
with: R₁═H, Methyl; X═O, NH,
i) an ion pair comonomer, and
a biocidal monomer selected from the group consisting of
j) a vinyl-imidazolium compound,
k) an ethylenically unsaturated monomer bearing at least one quaternary ammonium or phosphonium group,
l) a diallyldialkylammonium chloride,
m) an alkylaminoalkyl (meth)acrylate, an alkylaminoalkyl (meth)acrylamide, or both,
n) a polylysine (meth)acrylamide or (meth)acrylate,
o) alkyl-4-vinylpridinium and alkyl-2-vinyl-pyridinium salts,
p) an ethylenically unsaturated monomer bearing at least one of a guanide group and a biguanide group, and
q) a halamine.

2. The filtration system of claim 1, wherein said component is selected from the group consisting of a membrane, a separating layer of a membrane, a support layer of a membrane, a fabric layer of a membrane, a feed spacer of a membrane, a permeate spacer of a membrane, a casing of the filtration system, a piping of the filtration system, a joint of the filtration system, and a manifold of the filtration system.

3. The filtration system of claim 1, wherein said composition comprises at least one compound of formula (I): 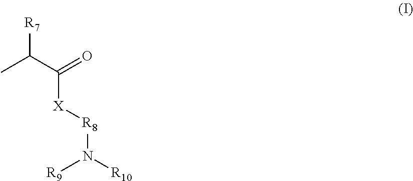
wherein
R₇ is H or CH₃,
R₈ is C₁-C₅ alkyl bi-radical,
R₉ and R₁₀ are independently H or C₁-C₅ alkyl radical which can be linear or branched, and
X is a divalent radical of —O—, —NH— or wherein R₁₁ is C₁-C₆alkyl.

4. The filtration system of claim 1, wherein said composition comprises 2-tert-butylaminoethyl (meth)acrylate or a combination of 2-Hydroxyethyl methacrylate and [2-(methacryloyloxy)ethyl]trimethylammonium chloride.

5. A membrane obtained by a process comprising:
A) treating a base membrane with at least one organoborane-amine complex;
B) treating the base membrane with a composition comprising at least one radically polymerizable compound; and
C) optional treating the base membrane with a deblocking agent, wherein said composition comprises at least one of
an antiadhesive monomer selected from the group consisting of
a) an ester of a (meth)acrylic acid polyol wherein (meth)acrylic esters with polyalkyleneoxides are excluded,
b) a vinyl ether of a polyol,
c) a hydrophilic macromonomer different from monomers a) and b),
d) an N-vinyl compound different from N-vinyl pyrrolidone,
e) a low molecular weight hydrophilic (meth)acrylamide,
f) a (meth)acrylate or (meth)acrylamide bearing at least one epoxy group,
g) a monomer having a betain structure,
h) a hydrophilic monomer selected from the group consisting of a hydroxyethyl-(meth)acrylate, vinyl alcohol, (Meth)acryloyl and (meth)acrylamide-modified mono- and oligosaccharides, 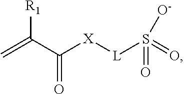
with: R₁═H, Methyl; X═O, NH,
i) an ion pair comonomer, and
a biocidal monomer selected from the group consisting of
j) a vinyl-imidazolium compound,
k) an ethylenically unsaturated monomer bearing at least one quaternary ammonium or phosphonium group,
l) a diallyldialkylammonium chloride,
m) an alkylaminoalkyl (meth)acrylate, an alkylaminoalkyl (meth)acrylamide, or both,
n) a polylysine (meth)acrylamide or (meth)acrylate,
o) alkyl-4-vinylpridinium and alkyl-2-vinyl-pyridinium salts,
p) an ethylenically unsaturated monomer bearing at least one of a guanide group and a biguanide group, and
q) a halamine.

6. The membrane of claim 5,
wherein said composition comprises at least one compound of formula (I): 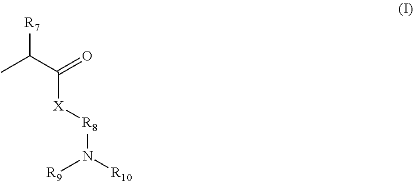
wherein
R₇ is H or CH₃,
R₈ is C₁-C₅ alkyl bi-radical,
R₉ and R₁₀ are independently H or C₁-C₅ alkyl radical which can be linear or branched, and
X is a divalent radical of —O—, —NH— or —NR₁₁, wherein R₁₁ is C₁-C₆alkyl.

7. The membrane of claim 5, wherein said composition comprises 2-tert-butylaminoethyl (meth)acrylate or a combination of 2-Hydroxyethyl methacrylate and [2-(methacryloyloxy)ethyl]trimethylammonium chloride.

8. The membrane of claim 5, wherein said organoborane-amine complex has a structure of formula (A):
R₁R₂R₃B—NR₄R₅R₆ (A),
wherein:
R₁, R₂ and R₃ are independently alkyl, aryl, alkoxy or aryloxy groups, with the proviso that at least one of R₁, R₂ and R₃ is an alkyl or aryl group, and
R₄, R₅ and R₆ are independently hydrogen, alkyl, cycloalkyl, substituted alkyl, alkoxy, alkylamino, aryl or heteroaryl groups, with the proviso that not more than two of R₄, R₅ and R₆ are simultaneously hydrogen, or
NR₄R₅R₆ is a heterocyclic aliphatic or aromatic amine, optionally comprising further heteroatoms selected from the group, consisting of N, O, S and P.

9. The membrane of claim 5, wherein said organoborane-amine complex is a trialkylborane-amine complex.

10. The membrane of claim 5, wherein said composition comprises at least one antiadhesive monomer and at least one biocidal monomer.

11. The membrane of claim 5, wherein the membrane or a separating layer of the membrane comprises as main component a polymer selected from the group consisting of a polyarylene ether, a polysulfone, a polyethersulfones (PES), a polyphenylensulfone (PPSU), a polyamide (PA), a polyvinylalcohol (PVA), a Cellulose Acetate (CA), a Cellulose Triacetate (CTA), a CA-triacetate blend, a Cellulose ester, a Cellulose Nitrate, a regenerated Cellulose, an aromatic, aromatic/aliphatic or aliphatic Polyamide, an aromatic, aromatic/aliphatic or aliphatic Polyimide, a Polybenzimidazole (PBI), a Polybenzimidazolone (PBIL), a Polyacrylonitrile (PAN), a PAN-poly(vinyl chloride) copolymer (PAN-PVC), a PAN-methallyl sulfonate copolymer, a Polysulfone, a Poly(dimethylphenylene oxide) (PPO), a Polycarbonate, a Polyester, a Polytetrafluoroethylene PTFE, a Poly(vinylidene fluoride) (PVDF), a Polypropylene (PP), a Polyelectrolyte complexes, a Poly(methyl methacrylate) PMMA, a Polydimethylsiloxane (PDMS), an aromatic, aromatic/aliphatic or aliphatic polyimide urethane, an aromatic, aromatic/aliphatic or aliphatic polyamidimide, a crosslinked polyimide, and mixtures thereof.

12. The membrane of claim 5, in which said membrane is adapted to function as at least one of a reverse osmosis membrane, forward osmosis membrane, nanofiltration membrane, ultrafiltration membrane and microfiltration membrane.

13. A process for making the membrane of claim 5, the process comprising:
A) treating a base membrane with at least one organoborane-amine complex;
B) treating the base membrane with a composition comprising at least one radically polymerizable compound; and
C) optional treating the base membrane with a deblocking agent, wherein said composition comprises at least one of
an antiadhesive monomer selected from the group consisting of
a) an ester of a (meth)acrylic acid polyol wherein (meth)acrylic esters with polyalkyleneoxides are excluded,
b) a vinyl ether of a polyol,
c) a hydrophilic macromonomer different from monomers a) and b),
d) an N-vinyl compound different from N-vinyl pyrrolidone,
e) a low molecular weight hydrophilic (meth)acrylamide,
f) a (meth)acrylate or (meth)acrylamide bearing at least one epoxy group,
g) a monomer having a betain structure,
h) a hydrophilic monomer selected from the group consisting of a hydroxyethyl-(meth)acrylate, vinyl alcohol, (Meth)acryloyl and (meth)acrylamide-modified mono- and oligosaccharides, 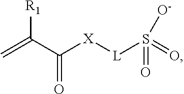
with: R₁═H, Methyl; X═O, NH,
i) an ion pair comonomer, and
a biocidal monomer selected from the group consisting of
j) a vinyl-imidazolium compound,
k) an ethylenically unsaturated monomer bearing at least one quaternary ammonium or phosphonium group,
l) a diallyldialkylammonium chloride,
m) an alkylaminoalkyl (meth)acrylate, an alkylaminoalkyl (meth)acrylamide, or both,
n) a polylysine (meth)acrylamide or (meth)acrylate,
o) alkyl-4-vinylpridinium and alkyl-2-vinyl-pyridinium salts,
p) an ethylenically unsaturated monomer bearing at least one of a guanide group and a biguanide group, and
q) a halamine.

14. The process of claim 13, wherein said composition comprises at least one compound of formula (I): 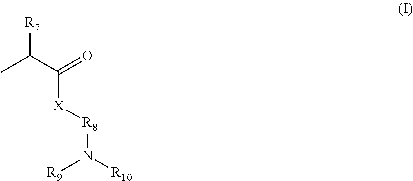
wherein
R₇ is H or CH₃,
R₈ is C₁-C₅ alkyl bi-radical,
R₉ and R₁₀ are independently H or C₁-C₅ alkyl radical which can be linear or branched, and
X is a divalent radical of —O—, —NH— or wherein R₁₁ is C₁-C₆ alky.

15. The process of claim 13, wherein said composition comprises 2-tert-butylaminoethyl (meth)acrylate or a combination of 2-Hydroxyethyl methacrylate and [2-(methacryloyloxy)ethyl]trimethylammonium chloride.

16. A process for treating water, the process comprising passing water through the membrane of the filtration system of claim 1.
